(19) United States
(12) Patent Application Publication
(10) Pub. No.: US 2026/0117083 A1
(43) Pub. Date: Apr. 30, 2026

(54) ACTIVE ENERGY RAY-CURABLE INKJET BLACK INK AND PRINTED MATTER

(71) Applicants: artience Co., Ltd., Tokyo (JP); TOYOCOLOR CO., LTD., Tokyo (JP)

(72) Inventors: Takumi YOSHIKAWA, Tokyo (JP); Yuji KAMEYAMA, Tokyo (JP); Norio SUZUKI, Tokyo (JP)

(73) Assignees: artience Co., Ltd., Tokyo (JP); TOYOCOLOR CO., LTD., Tokyo (JP)

(21) Appl. No.: 19/156,604

(22) PCT Filed: Oct. 30, 2024
(86) PCT No.: PCT/JP2024/038669

§ 371 Date: Aug. 14, 2025

(30) Foreign Application Priority Data
Feb. 16, 2024 (JP) 2024-022367

(51) Int. Cl. C09D 11/326; C09D 5/32

(52) U.S. Cl. CPC C09D 11/326; C09D 5/32

(57) ABSTRACT

An active energy ray-curable inkjet black ink includes carbon black, a basic pigment dispersing resin having an acid value of 30 mgKOH/g or less, and 5-methyl-3-vinyloxazolidin-2-one. When a DBP oil absorption amount of the carbon black is represented by AC (mL/100 g) and a specific surface area of the carbon black is represented by SC (m²/g), a value represented by AC×SC is 2,000 to 12,000. A content of a monofunctional polymerizable compound (excluding the 5-methyl-3-vinyloxazolidin-2-one) is 15% by mass or less with respect to a total mass of the active energy ray-curable inkjet black ink.

### TECHNICAL FIELD

Embodiments of the present invention relate to an active energy ray-curable inkjet black ink, and a printed matter obtained by printing the active energy ray-curable inkjet black ink on a printing substrate.

### BACKGROUND ART

In recent years, a digital printing method has been adopted in a printing market that focuses on productivity, such as a commercial printing market, an office printing market, and a special printing market. The first reason is that a printed matter can be obtained at low cost in a short time because the digital printing method does not require plate making. The second reason is that a printing apparatus is smaller and less expensive than a printing apparatus used in a forme-based printing method. The third reason is that it is possible to easily obtain a uniform printed matter regardless of a skill of a person engaged in printing.

In particular, an inkjet printing method, which is a type of digital printing method, has many advantages compared with other digital printing methods as represented by running cost for printing, ease of full-color printing, and independency of an installation environment of a printing apparatus on print quality. Therefore, in the printing market, a demand for adopting the inkjet printing method is particularly increasing.

An ink used in the inkjet printing method is in a wide variety of forms such as a water type, an oil type, a solvent type, and an active energy ray-curable type. Among these, in recent years, a demand for an active energy ray-curable ink is increasing due to the ability to produce a printed matter with high print quality on an non-permeable printing substrate, such as a resin film or glass, a short drying (curing) time, and properties such as the strength of a printed matter.

Meanwhile, in preparation of a printed matter, a black color is an extremely important color as visibility and readability in a printed matter of characters and bar codes, sharpness in a printed matter such as a photograph, and the like can be improved. However, in an active energy ray-curable ink used in the inkjet printing method (simply referred to as “active energy ray-curable inkjet ink” in the present specification), the black color is a color known to be difficult to improve its curability. This is because carbon black, which is generally used as a black colorant, absorbs an active energy ray. Insufficient curability leads to a decrease in printing speed. Therefore, in considering development in the above-described printing market focusing on productivity, improvement of curability in a black color active energy ray-curable inkjet ink is a very important issue.

Note that, in the past, studies have also been conducted on an active energy ray-curable inkjet ink in which a black color is reproduced by mixing a plurality of colorants without using carbon black (see, Patent Literature 1.). However, in such a method, it is difficult to reproduce a sharp black color, and further improvement is necessary from the viewpoint of improving the visibility, readability, and sharpness described above.

In addition, recently, a demand from a market for environmental consideration is increasing. From this viewpoint, as a method for curing an active energy ray-curable inkjet ink, an LED lamp is often adopted. However, the LED lamp has a characteristic that a wavelength range of an active energy ray to be emitted is narrow. Therefore, when the LED lamp is used in combination with an active energy ray-curable inkjet ink, improvement of curability is an issue.

Studies for improving curability of an active energy ray-curable inkjet ink when the active energy ray-curable inkjet ink is used in combination with the LED lamp have been conventionally conducted. Patent Literature 2 discloses a photocurable inkjet printing ink composition containing 4% to 40% by mass of vinyloxyethoxyethyl acrylate, and 10% to 65% by mass of benzyl acrylate, and further containing 50% by mass or more of a monofunctional monomer. However, in Examples of Patent Literature 2, printing evaluation using an inkjet printer (printing apparatus) is not actually performed, and whether a printed matter excellent in visibility, readability, and the like can be stably printed is not described. In addition, in consideration of adoption in the above-described printing market, it is considered that curability of the photocurable inkjet printing ink composition disclosed in Patent Literature 2 needs to be further improved.

Patent Literature 3 discloses an ultraviolet curable inkjet printing ink composition containing an α-aminoalkylphenone-based initiator, a thioxanthone-based initiator, and a tertiary amine (photopolymerization initiation assistant). However, in Examples of Patent Literature 3, curability is evaluated using an inkjet printer adopting a multi-pass printing method in which the irradiation of an active energy ray is performed a plurality of times in the same place. In addition, in the above Examples, evaluation is only preformed with a yellow color ink composition. As described above, the black color active energy ray-curable inkjet ink is difficult to improve curability as compared with other colors. Therefore, in consideration of adoption in the above-described printing market, even if the composition of Patent Literature 3 is simply developed in a black color active energy ray-curable inkjet ink, there is a high possibility that desired curability cannot be obtained in the active energy ray-curable inkjet ink.

Note that, when the composition disclosed in Patent Literature 3 is developed in a black color active energy ray-curable inkjet ink, a measure of enhancing sensitivity to an active energy ray and improving curability by increasing the blending amounts of an α-aminoalkylphenone-based initiator, a thioxanthone-based initiator, and a tertiary amine is also considered. However, many of the components described above are solid at ordinary temperature. Therefore, when a large amount of these components are blended, this may cause issues such as, deterioration of discharge stability from an inkjet head, deterioration of a dispersed state of a colorant (carbon black or the like), and the like. For this reason, simply increasing the amounts of the components described above is not necessarily a favorable measure.

As described above, conventionally, in a black color active energy ray-curable inkjet ink (also referred to as “active energy ray-curable inkjet black ink” in the present.

Note that, in the present specification, being excellent in visibility and readability even in a printed matter of fine characters and barcodes is referred to as “fineness of a printed matter”.

### CITATION LIST

### Patent Literature

Patent Literature 1: JP 2008-266548 A
Patent Literature 2: WO 2014/014017 A
Patent Literature 3: JP 2014-136795 A

### SUMMARY OF INVENTION

### Technical Problem

The present invention has been made in order to solve the above-described issues. An object of an embodiment of the present invention is to provide an active energy ray-curable inkjet black ink excellent in all of dispersion stability of carbon black, discharge stability, curability, and fineness of a printed matter.

### Solution to Problem

As a result of diligent studies, the present inventors have found that all of the above-described issues can be solved simultaneously at high levels by an active energy ray-curable inkjet black ink having the following composition.

That is, an embodiment of the present invention relates to an active energy ray-curable inkjet black ink. Another embodiment of the present invention relates to a printed matter obtained by using the active energy ray-curable inkjet black ink. Hereinafter, embodiments of the present invention will be specifically described, but the present invention is not limited to the following embodiments, and includes various embodiments.
[1] An active energy ray-curable inkjet black ink including carbon black, a basic pigment dispersing resin, and a polymerizable compound, wherein
when a DBP oil absorption amount of the carbon black is represented by AC (mL/100 g) and a specific surface area of the carbon black is represented by SC (m²/g), a value represented by AC×SC is 2,000 to 12,000,
the basic pigment dispersing resin has an acid value of 30 mgKOH/g or less,
the polymerizable compound contains 5-methyl-3-vinyloxazolidin-2-one, and
a content of a monofunctional polymerizable compound (excluding the 5-methyl-3-vinyloxazolidin-2-one) is 15% by mass or less with respect to a total mass of the active energy ray-curable inkjet black ink.
[2] The active energy ray-curable inkjet black ink according to [1], wherein
the polymerizable compound contains a radically polymerizable bifunctional monomer represented by the following general formula (A), and
a content of the radically polymerizable bifunctional monomer represented by the general formula (A) is within a range from 15% to 55% by mass with respect to a total mass of the active energy ray-curable inkjet black ink.

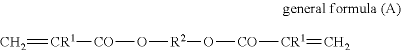

where (A), R¹ represents a hydrogen atom or a methyl group, and R² represents an alkylene group having 3 to 6 carbon atoms and optionally having a branched structure.
[3] The active energy ray-curable inkjet black ink according to [1] or [2], wherein
the polymerizable compound contains a radically polymerizable trifunctional monomer represented by general formula (B) below, and
a content of the radically polymerizable trifunctional monomer represented by the general formula (B) is within a range from 2% to 15% by mass with respect to a total mass of the active energy ray-curable inkjet black ink.

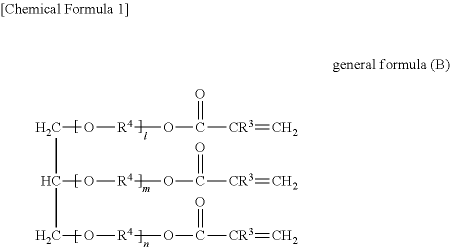

where R³ represents a hydrogen atom or a methyl group, R⁴ represents an ethylene group or a propylene group, 1, m and n each represent an integer of 0 to 9, and 1+m+n is an integer of 0 to 9.
[4] The active energy ray-curable inkjet black ink according to any one of [1] to [3], further including a photopolymerization initiator, wherein
the photopolymerization initiator contains an acylphosphine oxide-based compound.
[5] The active energy ray-curable inkjet black ink according to [4], wherein the photopolymerization initiator further contains a thioxanthone-based compound.
[6] The active energy ray-curable inkjet black ink according to [4] or [5], wherein
the acylphosphine oxide-based compound contains at least one selected from the group consisting of ethoxyphenyl (2,4,6-trimethylbenzoyl) phosphine oxide and a multimer of ethoxyphenyl (2,4,6-trimethylbenzoyl) phosphine oxide, and
a total of a content of the ethoxyphenyl (2,4,6-trimethylbenzoyl) phosphine oxide and a content of the multimer of the ethoxyphenyl (2,4,6-trimethylbenzoyl) phosphine oxide is within a range from 45% to 80% by mass with respect to a total mass of the photopolymerization initiator.
[7] The active energy ray-curable inkjet black ink according to any one of [1] to [6], wherein the carbon black has a pH of 2 to 5.
[8] A printed matter obtained by printing the active energy ray-curable inkjet black ink according to any one of [1] to [7] on a printing substrate.

The disclosure of the present application relates to subject matters described in Japanese Patent Application No. 2024-022367 filed on Feb. 16, 2024, the entire disclosure of which is incorporated herein by reference.

### Advantageous Effects of Invention

An active energy ray-curable inkjet black ink according to an embodiment of the present invention has an effect of being excellent in all of dispersion stability of carbon black, discharge stability, curability, and fineness of a printed matter.

### DESCRIPTION OF EMBODIMENTS

Hereinafter, an active energy ray-curable inkjet black ink according to an embodiment of the present invention (hereinafter, also simply referred to as “inkjet ink of the present embodiment”) will be described in detail. Note that the present invention is not limited to the following embodiments, and includes modifications performed without departing from the summary of the present invention.

In the present specification, the terms “(meth)acrylate”, “(meth)acryloyl”, and “(meth)acrylic acid” represent “acrylate and/or methacrylate”, “acryloyl and/or methacryloyl”, and “acrylic acid and/or methacrylic acid”, respectively.

To begin, a mechanism by which the above-described effect is exhibited by the composition of the inkjet ink of the present embodiment will be described. However, the mechanism described below is inference by the present inventors and does not limit the present invention at all.

First, the inkjet ink of the present embodiment contains 5-methyl-3-vinyloxazolidin-2-one as a polymerizable compound. As described above, it is generally known that a cyclic N-vinyl compound has a higher reaction rate with radicals derived from a photopolymerization initiator than an acrylate compound. In addition, a reaction rate of 5-methyl-3-vinyloxazolidin-2-one is particularly high as compared with other compounds. A reason for this is considered to be that 5-methyl-3-vinyloxazolidin-2-one is different in having an oxygen atom in a ring structure in comparison with N-vinylcaprolactam and N-vinylpyrrolidone which are generally known as cyclic N-vinyl compounds. That is, it is considered that electrons in the ring structure are attracted to the oxygen atom, whereby a vinyl group easily reacts with radicals derived from a photopolymerization initiator. As a result, smearing of fine characters and thin lines can be prevented, and a printed matter with high fineness can be easily obtained.

In addition, by setting the content of a monofunctional polymerizable compound (excluding 5-methyl-3-vinyloxazolidin-2-one) to 15% by mass or less with respect to the total mass of the inkjet ink of the present embodiment, a reaction between 5-methyl-3-vinyloxazolidin-2-one and radicals is not inhibited, and curability and fineness of a printed matter can be further improved.

Meanwhile, there is an issue that a cyclic N-vinyl compound such as 5-methyl-3-vinyloxazolidin-2-one easily deteriorates dispersion stability of a pigment and discharge stability of an inkjet ink. A reason for this may be that the cyclic N-vinyl compound inhibits stable adsorption of a pigment dispersant to a pigment surface, and a vinyl group in the cyclic N-vinyl compound reacts with an acid group present in a pigment dispersant and the like. In a case of an active energy ray-curable inkjet black ink containing carbon black, it is particularly difficult to improve curability. A reason for this is because that an active energy ray is absorbed by carbon black, and therefore the active energy ray does not easily penetrates into the interior, and a quinone group present on a surface of the carbon black traps radicals, and the like. Therefore, when 5-methyl-3-vinyloxazolidin-2-one is simply blended in an active energy ray-curable inkjet black ink containing carbon black, curability may be insufficient. Furthermore, dispersion stability of the carbon black and discharge stability of the inkjet black ink may deteriorated. Furthermore, deterioration in dispersion stability may also adversely affect fineness of a printed matter.

In contrast, the inkjet ink of the present embodiment uses carbon black having an AC×SC value of 2,000 to 12,000, in which AC (mL/100 g) represents a DBP oil absorption amount, and SC (m²/g) represents a specific surface area. The carbon black satisfying the requirement of the above value has large primary particles and relatively small aggregates which are formed from the primary particles. When such carbon black is used, although details are unknown, it is considered that the amount of an active energy ray absorbed is prevented, and the amount of radicals trapped on a surface can be reduced due to a small external surface area.

In addition, in the inkjet ink of the present embodiment, in order to disperse the carbon black, a basic pigment dispersing resin having an acid value of 30 mgKOH/g or less is used. Although details will be described later, the basic pigment dispersing resin has a basic group as an adsorption point with a pigment (carbon black). It is considered that such a basic group strongly interacts with a functional group such as a carboxy group, a hydroxyl group, or a quinone group present on a surface of the carbon black, whereby dispersion stability of the carbon black and discharge stability of the inkjet ink can be ensured even in the presence of 5-methyl-3-vinyloxazolidin-2-one. In addition, the discharge stability of the inkjet ink can be further improved by allowing the acid value of the basic pigment dispersing resin to be 30 mgKOH/g or less (may be 0 mgKOH/g) and using such a specific basic pigment dispersing resin to limit the amount of acid groups that can react with a vinyl group in 5-methyl-3-vinyloxazolidin-2-one.

As described above, when the active energy ray-curable inkjet black ink having the above-described composition is formed, all of dispersion stability of carbon black, discharge stability, curability, and fineness of a printed matter can be improved.

Subsequently, each of the components forming the inkjet ink of the present embodiment will be described in detail below.

Note that the inkjet ink of the present embodiment exhibits a black color. The “black color” inkjet ink includes not only an inkjet ink capable of preparing a black color printed matter but also an inkjet ink capable of preparing a light black (gray) color printed matter. However, in both the former case and the latter case, it goes without saying that the inkjet ink needs to have the above-described composition.

### <Carbon Black>

The inkjet ink of the present embodiment contains carbon black. When a DBP oil absorption amount of the carbon black is represented by AC (mL/100 g) and a specific surface area of the carbon black is represented by SC (m²/g), a value represented by AC×SC is 2,000 to 12,000.

### (DBP Oil Absorption Amount)

The DBP oil absorption amount is a value indicating how much DBP (dibutyl phthalate) is absorbed into particle voids present in an aggregate. In general, carbon black in which an aggregate is further developed has a larger DBP oil absorption amount value. A DBP oil absorption amount of carbon black that can be used in the inkjet ink of the present embodiment is preferably 40 to 100 mL/100 g, more preferably 40 to 80 mL/100 g, and particularly preferably 40 to 65 mL/100 g. An inkjet ink using carbon black having such a DBP oil absorption amount is excellent in curability. In addition, since the basic pigment dispersing resin can be strongly adsorbed to the carbon black, dispersion stability of the carbon black is also improved.

The DBP oil absorption amount can be measured according to JIS K 6217-4 using “absorptometer type C” manufactured by Blabender GmbH & Co. KG.

### (Specific Surface Area)

Generally, carbon black having a large specific surface area has small primary particles and/or many pores in the carbon black. A specific surface area of carbon black that can be used in the inkjet ink of the present embodiment is preferably 45 to 120 m²/g, and particularly preferably 50 to 95 m²/g. An active energy ray that has penetrated into the inkjet ink is not easily absorbed by carbon black having such a specific surface area, and radicals are not easily trapped on a surface of the carbon black. Therefore, curability is improved. In addition, since the amount of carbon black having an excessively large primary particle size is reduced, discharge stability is also improved.

In the present specification, a value measured using a nitrogen BET method is used as “specific surface area” (nitrogen BET specific surface area). A method for measuring a specific surface area of carbon black by the nitrogen BET method is specified in JIS K 6217-2, and the same applies to the present specification. Specific examples of the measurement method include a method in which nitrogen is adsorbed to degassed carbon black at a liquid nitrogen temperature, and a specific surface area (m²/g) is calculated from a nitrogen adsorption amount when equilibrium is reached.

### (Multiplication Value of DBP Oil Absorption Amount and Specific Surface Area)

As described above, the carbon black contained in the inkjet ink of the present embodiment has an AC×SC value of 2,000 to 12,000, in which AC (mL/100 g) represents a DBP oil absorption amount, and SC (m²/g) represents a specific surface area. In some embodiments, the value is preferably 2,000 to 7,500, and particularly preferably 2,000 to 6,000. According to the above embodiment, not only curability is improved, but also fineness of a printed matter can be easily improved. In addition, the carbon black is strongly adsorbed to the basic pigment dispersing resin, whereby dispersion stability of the carbon black and discharge stability of the inkjet ink can be easily improved.

(pH)

In addition to the specifications described above, a pH of carbon black contained in the inkjet ink of the present embodiment is preferably 2 to 5, and particularly preferably 2 to 4. In the case of carbon black having such a pH, since the basic pigment dispersing resin is strongly adsorbed to the carbon black, dispersion stability of the carbon black and discharge stability of the inkjet ink are particularly improved.

The pH of carbon black can be measured using a conventional method. For example, in a glass container such as a beaker, 5 g of carbon black and 50 mL of ion-exchanged water are mixed, and an opening of the beaker is covered with a watch glass and the like, and then the mixture is heated for 15 minutes. Note that a small amount (about 0.1 mL) of ethanol or acetone may be added in order to make the carbon black easily wettable. After boiling, the mixture is cooled to 25° C., and the supernatant is removed to obtain a muddy material. A pH electrode is inserted into the muddy material, and a pH is measured. For the measurement of the pH, for example, a tabletop PH meter “F-71” (manufactured by HORIBA, Ltd.) equipped with a pH electrode “9681S-10D” (manufactured by HORIBA, Ltd.) can be used.

### (Primary Particle Size)

For the same reason to that in the case of the specific surface area described above, that is, since curability and discharge stability are improved, a primary particle size of carbon black is preferably 20 to 50 nm, more preferably 25 to 50 nm, and particularly preferably 30 to 50 nm.

The primary particle size of carbon black can be measured using a conventional method. For example, the primary particle size can be obtained by observing carbon black with a transmission electron microscope (TEM), measuring sizes (diameters) of 100 primary particles of the carbon black, and then calculating the average value thereof.

The content of carbon black contained in the inkjet ink of the present embodiment and satisfying the above-described requirements is preferably 0.5 to 3.5% by mass, and particularly preferably 1.0 to 3.0% by mass with respect to the total mass of the inkjet ink. When the content of carbon black satisfying the above-described requirements is within the above ranges, the amount of carbon black present in the inkjet ink is a preferable, and therefore the inkjet ink is excellent in curability, discharge stability, and fineness of a printed matter.

In addition, a particle size (secondary particle size) of carbon black contained in the inkjet ink of the present embodiment and satisfying the above-described requirements is preferably 80 to 250 nm, and particularly preferably 100 to 200 nm. When the secondary particle size of carbon black satisfying the above-described requirements is within the above range, it can be said that the carbon black is in a preferable dispersed state. This makes it possible to easily obtain an inkjet ink excellent in all of curability, discharge stability, and dispersion stability of carbon black.

For the same reason, that is, since all of curability and discharge stability of the inkjet ink and dispersion stability of the carbon black are improved by the carbon black being in a preferable dispersed state, a value obtained by dividing the secondary particle size (unit: nm) by a specific surface area (unit: m²/g) of carbon black satisfying the above-described requirements is preferably 1.0 to 4.0, and particularly preferably 1.5 to 3.5.

The secondary particle size refers to a median diameter measured on a volume basis. In addition, the secondary particle size can be measured using a dynamic light scattering particle size distribution measuring apparatus (for example, “Nanotrac UPA-EX150” manufactured by MicrotracBEL Corp.), and using an inkjet ink diluted with ethyl acetate so as to have a concentration capable of measuring the secondary particle size in the particle size distribution measuring apparatus.

The inkjet ink of the present embodiment may contain carbon black (also referred to as “other carbon black” in the present specification) other than carbon black satisfying the above-described requirements. However, when the inkjet ink of the present embodiment contains other carbon black, the blending amount thereof is preferably an amount that does not inhibit the effect of carbon black satisfying the above-described requirements. Specifically, the content of other carbon black contained in the inkjet ink of the present embodiment is preferably in a range of 0 to 35% by mass with respect to the total mass of carbon black contained in the inkjet ink. That is, the content is preferably 35% by mass or less, more preferably 20% by mass or less, particularly preferably 10% by mass, and may be 0% by mass.

Note that a phrase “blending amount (content) is 0% by mass” in the present specification means that no target component is contained.

### <Other Pigment>

In addition, the inkjet ink of the present embodiment may contain a pigment (also referred to as “other pigment” in the present specification) other than carbon black from the viewpoint of improving curability and enhancing fineness and blackness of a printed matter. When the inkjet ink of the present embodiment contains other pigment, the content of the other pigment contained in the inkjet ink of the present embodiment is preferably in a range of 0 to 50% by mass with respect to the content of carbon black contained in the inkjet ink and satisfying the above-described requirements for the same reason to that in the case of the other carbon black described above, that is, for a reason that the effect of carbon black satisfying the above-described requirements is effectively exhibited, and curability, discharge stability, and dispersion stability of the carbon black are improved. That is, the content is preferably 50% by mass or less, more preferably 35% by mass or less, particularly preferably 20% by mass or less, and may be 0% by mass.

The other pigment is not particularly limited, but for example, an organic pigment or an inorganic pigment represented by the following color index name can be used.

Examples thereof include: C.I. Pigment Red 5, 7, 12, 17, 48 (Ca), 48 (Mn), 49:2, 57 (Ca), 57:1, 112, 122, 123, 147, 149, 150, 166, 168, 176, 177, 178, 184, 188, 202, 209, 242, 254, 255, 264, 266, 269, 282, and the like as a red pigment;
C.I. Pigment Violet 19, 23, and the like as a violet pigment;
C.I. Pigment Orange 5, 13, 34, 38, 43, 61, 62, 64, and the like as an orange pigment;
C.I. Pigment Blue 1, 2, 3, 15:3, 15:4, 15:6, 16, 22, 60, C.I. Vat Blue 4, 60, and the like as a blue pigment;
C.I. Pigment Green 7, 26, 36, 50, 58, and the like as a green pigment; and
C.I. Pigment Yellow 1, 2, 3, 12, 14, 16, 17, 73, 74, 75, 83, 93, 95, 97, 98, 109, 110, 114, 128, 129, 138, 139, 147, 150, 151, 154, 155, 180, 185, 213, and the like as a yellow pigment. Any of these pigments can be used depending on the desired curability and fineness and blackness of a printed matter. Two or more of the pigments listed above may be used in combination.

### <Basic Pigment Dispersing Resin>

The inkjet ink of the present embodiment contains a basic pigment dispersing resin. The basic pigment dispersing resin has an acid value of 30 mgKOH/g or less. Note that the acid value may be 0 mgKOH/g, that is, the basic pigment dispersing resin may have substantially no acid group.

The “basic pigment dispersing resin” in the present specification refers to a dispersing resin in which a basic group serves as an adsorption point to a surface of a pigment (carbon black). Examples of the basic group include a primary amino group, a secondary amino group, a tertiary amino group, a quaternary ammonium group, and an imino group. Organic groups bonded to nitrogen atoms in the tertiary amino group and the quaternary ammonium group may be bonded to each other to form a ring (heterocyclic ring containing the nitrogen atom) structure. Examples of the ring include pyridine, pyrrolidine, pyrrolidone, imidazoline, and caprolactam.

Note that even a pigment dispersing resin having an acid group in addition to a basic group is included in the “basic pigment dispersing resin” in the present specification as long as the basic group functions as the adsorption point. However, as described above, it is needless to say that in the present embodiment, it is necessary to use at least a basic pigment dispersing resin having an acid value of 30 mgKOH/g or less (may be 0 mgKOH/g).

Examples of the basic pigment dispersing resin include an acrylic resin having the basic group, an (anhydrous) maleic acid resin having the basic group, polyethyleneimine, polyallylamine, polydiallylamine, polyvinylimidazoline, polyvinylpyrrolidone, and a graft resin having any of these resins as a main chain.

Examples of a commercially available product of the basic pigment dispersing resin include the following:
“AJISPER-PB-821”, “AJISPER-PB-822”, “AJISPER-PB-824”, and “AJISPER-PB-881” manufactured by Ajinomoto Fine-Techno Co., Inc.:
“DISPERBYK-162”, “DISPERBYK-163”, “DISPERBYK-168”, “DISPERBYK-182”, “DISPERBYK-184”, “DISPERBYK-185”, “DISPERBYK-2013”, “DISPERBYK-2155”, “BYKJET-9150”, “BYKJET-9151”, and “BYKJET-9152” manufactured by BYK Japan KK;
“Solsperse24000”, “Solsperse32000”, “Solsperse33000”, “Solsperse35000”, “Solsperse39000”, “Solsperse86000”, “SolsperseJ200”, and “SolsperseX300” manufactured by Lubrizol Corporation; and
“EFKA PX4701”, “EFKA PX4703”, and “EFKA PX4733” manufactured by BASF.

Note that the “acrylic resin” represents a resin using one or more selected from the group consisting of acrylic acid, methacrylic acid, an acrylate, and a methacrylate as a monomer forming the resin. As the monomer forming the resin, a styrene-based monomer may be further used. However a resin using (anhydrous) maleic acid (maleic anhydride and/or maleic acid) as the monomer is not included in the “acrylic resin”.

The “(anhydrous) maleic acid resin” refers to a resin using at least (anhydrous) maleic acid as a monomer forming the resin. The (anhydrous) maleic acid resin may further use, as the monomer, one or more selected from the group consisting of an α-olefin, acrylic acid, methacrylic acid, an acrylate, a methacrylate, styrene, and a styrene derivative.

As described above, the acid value of the basic pigment dispersing resin is 30 mgKOH/g or less (may be 0 mgKOH/g) from the viewpoint of improving discharge stability and curability of the inkjet ink of the present embodiment. In addition, the acid value of the basic pigment dispersing resin is particularly preferably 20 mgKOH/g or less (may be 0 mgKOH/g) from the viewpoint that the basic pigment dispersing resin can be stably present in the inkjet ink, discharge stability can be further improved, and curability of the inkjet ink is also improved.

The “acid value” of the basic pigment dispersing resin is the number of mg of potassium hydroxide necessary for neutralizing 1 g of the resin, and can be determined using a potentiometric titration method in accordance with JIS K 0070. As a specific measurement method, a target resin is dissolved in a solvent obtained by mixing diethyl ether and ethanol at a mass ratio of 1:1, and then titration is performed with a potentiometric titration method using a 0.1 mol/L potassium hydroxide-ethanol solution. Then, an acid value can be calculated using a titration amount read from an obtained titration curve.

An amine value of the basic pigment dispersing resin is preferably 10 to 50 mgKOH/g, and particularly preferably 15 to 40 mgKOH/g. Since a basic pigment dispersing resin having an amine value within the above range has a sufficient amount of adsorption points, the basic pigment dispersing resin can be strongly adsorbed to carbon black satisfying the above requirements. As a result, dispersion stability of the carbon black and discharge stability of the inkjet ink are improved. Furthermore, since the adsorption point (basic group) does not inhibit a polymerization reaction and the like of a polymerizable compound, curability of the inkjet ink is also improved.

The “amine value” of the basic pigment dispersing resin is the number of mg of potassium hydroxide equivalent to an acid required to neutralize 1 g of the resin. As an example of a method for actually measuring the amine value, a target resin is dissolved in a solvent obtained by mixing ethanol or tetrahydrofuran and acetic acid, and then titration is performed with a potentiometric titration method using a 0.1 mol/L perchloric acid-acetic acid solution. Then, by conversion into the number of mg of potassium hydroxide using a titration amount read from an obtained titration curve, the amine value can be calculated.

A mass average molecular weight of the basic pigment dispersing resin is preferably 5,000 to 60,000, more preferably 8,000 to 55,000, and particularly preferably 10,000 to 50,000. When the mass average molecular weight of the basic pigment dispersing resin is within the above range, compatibility of the basic pigment dispersing resin with a polymerizable compound is improved, and discharge stability is improved. In addition, since the basic pigment dispersing resin can be strongly adsorbed to carbon black satisfying the above-described requirements, dispersion stability of the carbon black is improved.

The mass average molecular weight can be measured using gel permeation chromatography (GPC). Specifically, the mass average molecular weight is a value obtained as a polystyrene-equivalent molecular weight measured using DMF as a developing solvent in GPC (for example, “HLC-8320GPC” manufactured by Tosoh Corporation) equipped with an RI detector using a TSKgel column (manufactured by Tosoh Corporation).

A blending amount of the basic pigment dispersing resin is preferably 10 to 100% by mass, more preferably 15 to 70% by mass, and particularly preferably 20 to 50% by mass with respect to the total amount of pigment components contained in the inkjet ink of the present embodiment. The total amount of pigment means the total amount of carbon black satisfying the above-described requirements and any other carbon black and/or other pigment which may be used. By using the basic pigment dispersing resin in a blending amount within the above range, dispersion stability of the pigment components containing carbon black satisfying the above-described requirements is improved, and discharge stability of the inkjet ink of the present embodiment is also improved.

### <Polymerizable Compound>

In the present embodiment, the polymerizable compound refers to a compound having a function of causing a polymerization reaction or a crosslinking reaction to proceed by radicals generated from a photopolymerization initiator and the like described later to cure a composition containing the polymerizable compound.

As described above, the inkjet ink of the present embodiment contains 5-methyl-3-vinyloxazolidin-2-one as a polymerizable compound. In addition, the content of a monofunctional polymerizable compound excluding the 5-methyl-3-vinyloxazolidin-2-one is 15% by mass or less with respect to the total mass of the inkjet ink.

### 5-Methyl-3-vinyloxazolidin-2-one

As described above, 5-methyl-3-vinyloxazolidin-2-one is particularly excellent in curability as compared with an N-vinyl compound other than the 5-methyl-3-vinyloxazolidin-2-one. The 5-methyl-3-vinyloxazolidin-2-one is also excellent in safety and odor. Therefore, the inkjet ink of the present embodiment containing 5-methyl-3-vinyloxazolidin-2-one is excellent in the above properties.

The content of 5-methyl-3-vinyloxazolidin-2-one is preferably 5 to 40% by mass, more preferably 10 to 35% by mass, and particularly preferably 15 to 30% by mass with respect to the total mass of the inkjet ink of the present embodiment. By setting the content of 5-methyl-3-vinyloxazolidin-2-one within the above range, an inkjet ink excellent in curability can be obtained. As a result, fineness of a printed matter is also improved. Furthermore, it is possible to prevent inhibition of stable adsorption of the basic pigment dispersing resin to a surface of carbon black satisfying the above-described requirements, and to prevent a reaction with an acid group present in the basic pigment dispersing resin. As a result, dispersion stability of the carbon black and discharge stability of the inkjet ink are also improved.

### (Other Polymerizable Compound)

The inkjet ink of the present embodiment may contain a polymerizable compound having radical polymerizability other than the 5-methyl-3-vinyloxazolidin-2-one (also referred to as “other polymerizable compound” in the present specification). A compound that can be used as the other polymerizable compound is not limited, and a monomer, an oligomer, a polymer, and the like having one or more polymerizable groups can be used.

Note that the “oligomer” and the “polymer” are polymers in which a plurality of monomers are bonded to each other, and are classified depending on the degree of polymerization. In the present specification, one having the degree of polymerization of 2 to 10 is referred to as an “oligomer”, and one having the degree of polymerization of 11 or more is referred to as a “polymer”.

Examples of a polymerizable group of the polymerizable compound having radical polymerizability (radically polymerizable compound) include a (meth)acryloyl group, a vinyl ether group, an allyl group, and a vinyl group (excluding a vinyl ether group and an allyl group). Among the polymerizable groups, it is preferable to use a radically polymerizable compound having one or more polymerizable groups selected from the group consisting of an acryloyl group, a vinyl ether group, and a vinyl group (excluding a vinyl ether group and an allyl groups) from the viewpoint of excellent curability.

In addition, as the other polymerizable compound, a monofunctional polymerizable compound (monofunctional polymerizable compound) may be used, or a bifunctional or higher (polyfunctional) polymerizable compound (polyfunctional polymerizable compound) may be used. Furthermore, the other polymerizable compound may be used singly or in mixture of a plurality of polymerizable compounds.

Note that the “monofunctional” refers to a compound having only one polymerizable group in one molecule, and the “bifunctional” and the “trifunctional” refer to a compound having two polymerizable groups in one molecule and a compound having three polymerizable groups in one molecule, respectively. The bifunctional or higher are collectively referred to as “polyfunctional”.

As described above, the inkjet ink of the present embodiment can use any other polymerizable compound. Meanwhile, in the inkjet ink of the present embodiment, the content of a monofunctional polymerizable compound (excluding 5-methyl-3-vinyloxazolidin-2-one) is 15% by mass or less with respect to the total mass of the inkjet ink of the present embodiment. This is for further improving curability and fineness of a printed matter by limiting the content of the monofunctional polymerizable compound excluding 5-methyl-3-vinyloxazolidin-2-one. From this viewpoint, the content of the monofunctional polymerizable compound (excluding 5-methyl-3-vinyloxazolidin-2-one) is preferably as small as possible. Specifically, the content of the monofunctional polymerizable compound (excluding 5-methyl-3-vinyloxazolidin-2-one) is preferably 10% by mass or less, more preferably 6% by mass or less, and particularly preferably 3% by mass or less with respect to the total mass of the inkjet ink of the present embodiment.

Examples of a monofunctional radically polymerizable compound (radically polymerizable monofunctional monomer) that can be used as the other polymerizable compound and is a monomer include a compound having one (meth)acryloyl group. Specific examples of such compounds include benzyl (meth)acrylate, 2-phenoxyethyl (meth)acrylate, ethylene oxide-modified 2-phenoxyethyl (meth)acrylate, propylene oxide-modified 2-phenoxyethyl (meth)acrylate, dicyclopentenyl (oxyethyl) (meth)acrylate, 2-methoxyethyl (meth)acrylate, methoxytriethylene glycol (meth)acrylate, 2-ethoxyethyl (meth)acrylate, 2-(2-ethoxyethoxy) ethyl (meth)acrylate, methoxydipropylene glycol (meth)acrylate, dipropylene glycol (meth)acrylate, ethylene oxide-modified nonylphenol acrylate, propylene oxide-modified nonylphenol acrylate, ethylene oxide-modified o-phenylphenol acrylate, ethylene oxide-modified 2-ethylhexyl acrylate, β-carboxylethyl (meth)acrylate, trimethylolpropane formal (meth)acrylate, tetrahydrofurfuryl (meth)acrylate, cyclohexyl (meth)acrylate, 3,3,5-trimethylcyclohexyl acrylate, 4-tert-butylcyclohexyl acrylate, isobornyl (meth)acrylate, norbornyl (meth)acrylate, dicyclopentanyl (meth)acrylate, isoamyl (meth)acrylate, isononyl (meth)acrylate, n-octyl (meth)acrylate, isooctyl (meth)acrylate, lauryl (meth)acrylate, isodecyl (meth)acrylate, tridecyl (meth)acrylate, stearyl (meth)acrylate, caprolactone (meth)acrylate, 2-hydroxy-3-phenoxypropyl (meth)acrylate, 1,4-cyclohexanedimethanol (meth)acrylate, 2-hydroxyethyl (meth)acrylate, 2-hydroxypropyl (meth)acrylate, 4-hydroxybutyl (meth)acrylate, (meth)acryloylmorpholine, 2-(diethylamino) ethyl (meth)acrylate, 2-(diisopropylamino) ethyl (meth)acrylate, tert-butylaminoethyl (meth)acrylate, morpholinoethyl (meth)acrylate, 2-(diethylamino) ethyl (meth)acrylate, and N-(meth)acryloyloxyethylhexahydrophthalimide.

In addition, another example of the radically polymerizable monofunctional monomer, which can be used as the other polymerizable compound, is a compound obtained by adding (Michael-addition) a primary or secondary organic amine to each of polymerizable groups except for one polymerizable group in a polyfunctional radically polymerizable compound (specific examples will be described later).

Furthermore, other examples of the radically polymerizable monofunctional monomer, which can be used as the other polymerizable compound, include compounds having one vinyl group (excluding 5-methyl-3-vinyloxazolidin-2-one). Specific examples thereof include N-vinylcaprolactam and N-vinylpyrrolidone.

Examples of a bifunctional radically polymerizable compound (radically polymerizable bifunctional monomer) that can be used as the other polymerizable compound and is a monomer include compounds having two (meth)acryloyl groups. Specific examples of such compounds include 1,3-propanediol di(meth)acrylate, 1,4-butanediol di(meth)acrylate, 1,3-butylenediol di(meth)acrylate, 1,6-hexanediol di(meth)acrylate, ethylene oxide-modified 1,6-hexanediol di(meth)acrylate, propylene oxide-modified 1,6-hexanediol di(meth)acrylate, 1,9-nonanediol di(meth)acrylate, 1,10-decanediol di(meth)acrylate, neopentyl glycol di(meth)acrylate, ethylene oxide-modified neopentyl glycol di(meth)acrylate, propylene oxide-modified neopentyl glycol di(meth)acrylate, 3-methyl-1,5-pentanediol di(meth)acrylate, 2,4-dimethyl-1,5-pentanediol di(meth)acrylate, 2-ethyl-2-butylpropanediol di(meth)acrylate, 2-ethyl-2-butylbutanediol di(meth)acrylate, ethylene oxide-modified cyclohexanemethanol di(meth)acrylate, ethylene glycol di(meth)acrylate, diethylene glycol di(meth)acrylate, triethylene glycol di(meth)acrylate, polyethylene glycol 200 di(meth)acrylate, polyethylene glycol 300 di(meth)acrylate, polyethylene glycol 400 di(meth)acrylate, hydroxypivalic acid neopentyl glycol di(meth)acrylate, bisphenol A di(meth)acrylate, ethylene oxide-modified bisphenol A di(meth)acrylate, propylene oxide-modified bisphenol A di(meth)acrylate, bisphenol F di(meth)acrylate, ethylene oxide-modified bisphenol F di(meth)acrylate, propylene oxide-modified bisphenol F di(meth)acrylate, dipropylene glycol di(meth)acrylate, tripropylene glycol di(meth)acrylate, polypropylene glycol di(meth)acrylate, ethylene oxide-modified isocyanuric acid di(meth)acrylate, tricyclodecane di(meth)acrylate, dimethyloltricyclodecane di(meth)acrylate, cyclohexanedimethanol di(meth)acrylate, trimethylolpropane (meth)acrylate, neopentyl glycol-modified trimethylolpropane di(meth)acrylate, and dicyclopentanyl di(meth)acrylate.

In addition, another examples of the radically polymerizable monofunctional monomer, which can be used as the other polymerizable compound, is a compound obtained by adding (Michael-addition) a primary or secondary organic amine to each of polymerizable groups except for two polymerizable groups in a polyfunctional radically polymerizable compound having three or more polymerizable groups (specific examples will be described later).

Furthermore, another examples of the radically polymerizable bifunctional monomer, which can be used as the other polymerizable compound, is a compound having one (meth)acryloyl group and one vinyl ether group. Specific examples thereof include 2-(2-vinyloxyethoxy) ethyl (meth)acrylate and 2-[2-(2-vinyloxyethoxy) ethoxy] ethyl (meth)acrylate.

Examples of a trifunctional radically polymerizable compound (radically polymerizable trifunctional monomer) that can be used as the other polymerizable compound and is a monomer include compounds having three (meth)acryloyl groups. Specific examples of such compounds include trimethylolpropane tri(meth)acrylate, trimethylolethane tri(meth)acrylate, ethylene oxide-modified trimethylolpropane tri(meth)acrylate, propylene oxide-modified trimethylolpropane tri(meth)acrylate, glycerin tri(meth)acrylate, ethylene oxide-modified glycerin tri(meth)acrylate, propylene oxide-modified glycerin tri(meth)acrylate, ethylene oxide-modified isocyanuric acid tri(meth)acrylate, propylene oxide-modified isocyanuric acid tri(meth)acrylate, propylene oxide-modified dipentaerythritol tri(meth)acrylate tetramethylolmethane tri(meth)acrylate, pentaerythritol tri(meth)acrylate, dipentaerythritol tri(meth)acrylate, tri((meth)acryloyloxyethyl) isocyanurate, hydroxypivalaldehyde-modified dimethylolpropane tri(meth)acrylate, and sorbitol tri(meth)acrylate.

Examples of a tetrafunctional radically polymerizable compound (radically polymerizable tetrafunctional monomer) that can be used as the other polymerizable compound and is a monomer include compounds having four (meth)acryloyl groups. Specific examples of such compounds include pentaerythritol tetra(meth)acrylate, sorbitol tetra(meth)acrylate, ditrimethylolpropane tetra(meth)acrylate, ethylene oxide-modified pentaerythritol tetra(meth)acrylate, propylene oxide-modified pentaerythritol tetra(meth)acrylate, and tetramethylolmethane tetra(meth)acrylate.

Examples of a pentafunctional radically polymerizable compound (radically polymerizable pentafunctional monomer) that can be used as the other polymerizable compound and is a monomer include compounds having five (meth)acryloyl groups. Specific examples of such compounds include sorbitol penta(meth)acrylate and dipentaerythritol penta(meth)acrylate.

Examples of a hexafunctional radically polymerizable compound (radically polymerizable hexafunctional monomer) that can be used as the other polymerizable compound and is a monomer include compounds having six (meth)acryloyl groups. Specific examples of such compounds include dipentaerythritol hexa(meth)acrylate, sorbitol hexa(meth)acrylate, alkylene oxide-modified hexa(meth)acrylate of phosphazene, and ε-captolactone-modified dipentaerythritol hexa(meth)acrylate.

Furthermore, as the other polymerizable compound, a radically polymerizable compound that is an oligomer (radically polymerizable oligomer) can also be used. In this case, a compound having a (meth)acryloyl group as a polymerizable group can be preferably used. The number of polymerizable groups included in the radically polymerizable oligomer is preferably 1 to 6 per molecule from the viewpoint of a balance among curability, discharge stability, and dispersion stability. The number of polymerizable groups is more preferably 1 to 4, and particularly preferably 1 or 2. A mass average molecular weight of the radically polymerizable oligomer is preferably 400 to 6,000, and more preferably 500 to 4,500.

Examples of the radically polymerizable oligomer having a (meth)acryloyl group include a urethane (meth)acrylate oligomer such as an aliphatic urethane (meth)acrylate oligomer or an aromatic urethane (meth)acrylate oligomer, an acrylic (meth)acrylate oligomer, a polyester (meth)acrylate oligomer, a polyether (meth)acrylate oligomer, and an epoxy (meth)acrylate oligomer.

The oligomer described above may be modified. Examples of the modification include sulfonic acid modification, phosphoric acid modification, amino modification, and mercapto modification.

When the inkjet ink of the present embodiment contains the other polymerizable compound, the inkjet ink preferably contains a radically polymerizable bifunctional monomer and/or a radically polymerizable trifunctional monomer from the viewpoint of improving all of curability, discharge stability, and fineness of a printed matter. In particular, the inkjet ink of the present embodiment preferably uses, as the other polymerizable compound, a radically polymerizable bifunctional monomer represented by the following general formula (A) and/or a radically polymerizable trifunctional monomer represented by the following general formula (B).

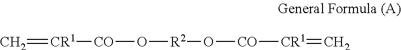

In the general formula (A), R¹ represents a hydrogen atom or a methyl group, and R² represents an alkylene group having 3 to 6 carbon atoms and optionally having a branched structure.

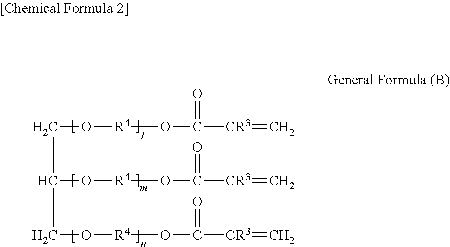

In the general formula (B), R³ represents a hydrogen atom or a methyl group, and R⁴ represents an ethylene group or a propylene group. In addition, l, m, and n each represent an integer of 0 to 9, and 1+m+n is an integer of 0 to 9.

The radically polymerizable bifunctional monomer represented by the general formula (A) has a low viscosity and a relatively low surface tension. Therefore, the inkjet ink containing the radically polymerizable bifunctional monomer represented by the general formula (A) is excellent in wet-spreadability on a printing substrate, and as a result, has improved curability. In addition, since the radically polymerizable bifunctional monomer represented by the general formula (A) is well compatible with 5-methyl-3-vinyloxazolidin-2-one, a polymerization reaction proceeds rapidly, and curability can be further improved. In addition, deterioration of dispersion stability of carbon black due to the 5-methyl-3-vinyloxazolidin-2-one is prevented, and dispersion stability of the carbon black can be improved.

Specific examples of the radically polymerizable bifunctional monomer represented by the general formula (A) include 1,3-propanediol di(meth)acrylate, 1,4-butanediol di(meth)acrylate, 1,3-butylenediol di(meth)acrylate, 1,6-hexanediol di(meth)acrylate, neopentyl glycol di(meth)acrylate, and 3-methyl-1,5-pentanediol di(meth)acrylate.

When the inkjet ink of the present embodiment contains the radically polymerizable bifunctional monomer represented by the general formula (A), the blending amount thereof is preferably 15 to 55% by mass, and particularly preferably 25 to 45% by mass with respect to the total mass of the inkjet ink. When the blending amount is in the above range, both curability and dispersion stability of carbon black are improved, and fineness of a printed matter is also improved.

In contrast, the radically polymerizable trifunctional monomer represented by the general formula (B) has a low viscosity among radically polymerizable trifunctional monomers, and therefore both discharge stability and curability of the inkjet ink can easily be achieved. In addition, since the radically polymerizable trifunctional monomer represented by the general formula (B) does not inhibit the effect of 5-methyl-3-vinyloxazolidin-2-one described above, curability can be further improved.

Specific examples of the radically polymerizable trifunctional monomer represented by the general formula (B) include glycerin tri(meth)acrylate, ethylene oxide-modified glycerin tri(meth)acrylate (the number of ethylene oxide groups: 3), ethylene oxide-modified glycerin tri(meth)acrylate (the number of ethylene oxide groups: 9), and propylene oxide-modified glycerin tri(meth)acrylate (the number of propylene oxide groups: 3).

When the inkjet ink of the present embodiment contains the radically polymerizable trifunctional monomer represented by the general formula (B), the blending amount thereof is preferably 2 to 15% by mass, and particularly preferably 5 to 12% by mass with respect to the total mass of the inkjet ink from the viewpoint of improving both curability and discharge stability, and further improving fineness of a printed matter.

In an embodiment, the inkjet ink preferably contains both the radically polymerizable bifunctional monomer represented by the general formula (A) and the radically polymerizable trifunctional monomer represented by the general formula (B). This makes it easy to obtain an inkjet ink excellent in all of curability, discharge stability, dispersion stability of carbon black, and fineness of a printed matter.

When the inkjet ink of the present embodiment contains the radically polymerizable bifunctional monomer represented by the general formula (A) and the radically polymerizable trifunctional monomer represented by the general formula (B), the mass content of the radically polymerizable bifunctional monomer represented by the general formula (A) contained in the inkjet ink is preferably 2 to 20, and particularly preferably 2.5 to 15, in which the mass content of the radically polymerizable trifunctional monomer represented by the general formula (B) contained in the inkjet ink is 1.

When the inkjet ink of the present embodiment contains a radically polymerizable bifunctional monomer and/or a radically polymerizable trifunctional monomer as the other polymerizable compound, the total amount of the content of 5-methyl-3-vinyloxazolidin-2-one and the content of the radically polymerizable bifunctional monomer and/or the radically polymerizable trifunctional monomer is preferably 75 to 100% by mass, more preferably 90 to 100% by mass, and particularly preferably 95 to 100% by mass with respect to the total mass of the polymerizable compounds contained in the inkjet ink from the viewpoint that both curability and discharge stability are improved.

In some embodiments, the mass content of the other polymerizable compound is preferably 1 to 15, and particularly preferably 1.2 to 5, in which the mass content of 5-methyl-3-vinyloxazolidin-2-one is 1. According to the above embodiment, dispersion stability of carbon black and discharge stability of the inkjet ink can be easily improved without inhibiting the effect of 5-methyl-3-vinyloxazolidin-2-one described above.

As described above, in the inkjet ink of the present embodiment, the content of a monofunctional polymerizable compound excluding 5-methyl-3-vinyloxazolidin-2-one is limited. Therefore, in some embodiments, it is preferable not to use a radically polymerizable monofunctional monomer as the other polymerizable compound. In some embodiments, the use amount of the radically polymerizable monofunctional monomer is preferably 15% by mass or less, preferably 10% by mass or less, more preferably 6% by mass or less, and particularly preferably 3% by mass or less.

In contrast, when a radically polymerizable monofunctional monomer is used as the other polymerizable compound, a (meth)acrylate having an alicyclic structure can be preferably used from the viewpoints that wet-spreadability of the inkjet ink on a printing substrate is improved, and as a result, curability is improved, and deterioration of dispersion stability of carbon black can be prevented. Specific examples of the (meth)acrylate having an alicyclic structure include cyclohexyl (meth)acrylate, 3,3,5-trimethylcyclohexyl acrylate, 4-tert-butylcyclohexyl acrylate, isobornyl (meth)acrylate, norbornyl (meth)acrylate, and dicyclopentanyl (meth)acrylate.

### <Photopolymerization Initiator>

The inkjet ink of the present embodiment preferably contains a photopolymerization initiator serving as a radical generation source. As the photopolymerization initiator, any one or more conventionally known compounds can be used. Specifically, an acylphosphine oxide-based compound, a benzophenone-based compound, an indane-based compound, a thioxanthone-based compound, a hydroxyacetophenone-based compound, an alkylaminoacetophenone-based compound, an oxime ester-based compound, and the like can be used.

The “polymerizable initiator” in the present specification also includes a material that is generally referred to as a sensitizer and promotes radical generation of another photopolymerization initiator. Examples of such a material include an aminobenzoate-based compound, a ketocoumarin-based compound, and an anthracene-based compound.

Among these photopolymerization initiators, one or more photopolymerization initiators selected from the group consisting of an acylphosphine oxide-based compound and a thioxanthone-based compound are preferably used, and at least an acylphosphine oxide-based compound is particularly preferably used from the viewpoint that curability can be particularly improved while dispersion stability of carbon black is maintained in a preferable state.

In addition, it is extremely preferable to use an acylphosphine oxide-based compound and a thioxanthone-based compound in combination as a photopolymerization initiator from the viewpoint of obtaining an inkjet ink that is particularly excellent in curability and fineness of a printed matter, and further has favorable discharge stability and favorable dispersion stability of carbon black.

In an embodiment, it is preferable to use one or more photopolymerization initiators selected from the group consisting of an acylphosphine oxide-based compound and a thioxanthone-based compound in combination with one or more photopolymerization initiators selected from the group consisting of an aminobenzoate-based compound and a ketocoumarin-based compound from the viewpoint of particularly improving curability.

### (Acylphosphine Oxide-Based Compound)

Specific examples of the acylphosphine oxide-based compound include diphenyl(2,4,6-trimethylbenzoyl) phosphine oxide, ethoxyphenyl (2,4,6-trimethylbenzoyl) phosphine oxide, phenylbis(2,4,6-trimethylbenzoyl) phosphine oxide, and multimers of these compounds. Examples of a commercially available product of the acylphosphine oxide-based compound include “Omnirad TPO”, “Omnirad TPO-L”, “Omnirad TPO-H”, “Omnirad 819”, and “OMNIPOL TP” manufactured by IGM RESINS B.V.; and “Speedcure TPO”, “Speedcure TPO-L”, and “Speedcure BPO” manufactured by Lambson. In addition, acylphosphine oxide-based compounds described in WO 2017/086224 A and WO 2020/049378 A and lithium phenyl (2,4,6-trimethylbenzoyl) phosphinate can also be used.

In the inkjet ink of the present embodiment, the acylphosphine oxide-based compounds listed above may be used singly or in combination of two or more types thereof.

Among these compounds, ethoxyphenyl (2,4,6-trimethylbenzoyl) phosphine oxide and/or a multimer of ethoxyphenyl (2,4,6-trimethylbenzoyl) phosphine oxide can be preferably used from the viewpoint of high affinity with 5-methyl-3-vinyloxazolidin-2-one and improvement in curability and discharge stability.

The content (total amount) of at least one selected from the group consisting of ethoxyphenyl (2,4,6-trimethylbenzoyl) phosphine oxide and a multimer of ethoxyphenyl (2,4,6-trimethylbenzoyl) phosphine oxide is preferably 45 to 80% by mass, and particularly preferably 50 to 70% by mass with respect to the total mass of photopolymerization initiators contained in the inkjet ink of the present embodiment from the viewpoint that curability and fineness of a printed matter can be improved without deteriorating discharge stability and dispersion stability of carbon black.

Note that when the inkjet ink of the present embodiment contains only one selected from the group consisting of ethoxyphenyl (2,4,6-trimethylbenzoyl) phosphine oxide and a multimer of ethoxyphenyl (2,4,6-trimethylbenzoyl) phosphine oxide, the above “content (total amount)” represents the content of the compound. When the inkjet ink of the present embodiment contains two or more selected from the group consisting of ethoxyphenyl (2,4,6-trimethylbenzoyl) phosphine oxide and a multimer of ethoxyphenyl (2,4,6-trimethylbenzoyl) phosphine oxide, the above “content (total amount)” represents the total amount of these compounds.

When the inkjet ink of the present embodiment contains an acylphosphine oxide-based compound, the blending amount thereof is preferably 4 to 15% by mass, and particularly preferably 5 to 12% by mass with respect to the total mass of the inkjet ink. When the blending amount is adjusted within the above range, an inkjet ink excellent in all of curability, discharge stability, and dispersion stability of carbon black is easily obtained. The mass content of the acylphosphine oxide-based compound is preferably 0.15 to 2, and particularly preferably 0.2 to 0.8, in which the mass content of 5-methyl-3-vinyloxazolidin-2-one contained is 1, from the viewpoint of easily obtaining an inkjet ink excellent in curability and discharge stability.

### (Thioxanthone-Based Compound)

Specific examples of the thioxanthone-based compound include 2-isopropylthioxanthone, 4-isopropylthioxanthone, 2,4-diethylthioxanthone, 3-methoxythioxanthone, 2-carboxymethoxythioxanthone, 3-ethoxycarbonylmethoxythioxanthone, 3-butoxycarboxymethoxythioxanthone, 1,3-dimethyl-2-(2-ethylhexyloxy) thioxanthone, 2-[2,2-bis(ethoxycarbonyl)] ethylthioxanthone, 1-chloro-4-propoxythioxanthone, and multimers of these compounds.

Examples of commercially available products of the thioxanthone-based compound include “Omnirad ITX”, “Omnirad DETX”, and “OMNIPOL TX” manufactured by IGM RESINS B. V.: “SPEEDCURE ITX”, “SPEEDCURE 2-ITX”, “SPEEDCURE DETX”, “SPEEDCURE LTX”, “SPEEDCURE CPTX”, and “SPEEDCURE 7010” manufactured by Lambson; and “Genopol TX-2” manufactured by RAHN. Note that among these commercially available products, “OMNIPOL TX”, “SPEEDCURE 7010”, and “Genopol TX-2” are the multimers described above. In the inkjet ink of the present embodiment, the thioxanthone-based compounds listed above may be used singly or in combination of two or more types thereof.

When the inkjet ink of the present embodiment contains a thioxanthone-based compound, the blending amount thereof is preferably 0.5 to 8% by mass, and particularly preferably 1 to 5% by mass with respect to the total mass of the inkjet ink. When the blending amount of the thioxanthone-based compound is adjusted within the above range, an inkjet ink excellent in all of curability, discharge stability, and dispersion stability of carbon black is easily obtained.

As described above, the inkjet ink of the present embodiment preferably uses an acylphosphine oxide-based compound and a thioxanthone-based compound in combination. In an embodiment in which the compounds are used in combination, the mass content of the acylphosphine oxide-based compound is preferably 1 to 25, and particularly preferably 2 to 12, in which the mass content of the thioxanthone-based compound is 1. When the content is adjusted within the above range, an inkjet ink excellent in both curability and fineness of a printed matter can be easily formed.

In addition, the mass content of the acylphosphine oxide-based compound is preferably 0.1 to 1.0, and particularly preferably 0.2 to 0.85, in which a sum of the mass content of the thioxanthone-based compound and the mass content of 5-methyl-3-vinyloxazolidin-2-one is 1. When the content is adjusted within the above range, discharge stability is also improved in addition to curability and fineness of a printed matter.

### (Aminobenzoate-Based Compound)

Specific examples of the aminobenzoate-based compound include methyl 2-(dimethylamino) benzoate, ethyl 4-(dimethylamino) benzoate, ethyl 4-(diethylamino) benzoate, 2-ethylhexyl 2-(dimethylamino) benzoate, 2-butoxyethyl 2-(dimethylamino) benzoate, bis-[(4-dimethylaminobenzoyl)oxyethylene-1-yl]-methylamine, and multimers of these compounds (for example, polyethylene glycol-bis(methyl 4-dimethylaminobenzoate)). Examples of a commercially available product of the aminobenzoate-based compound include “Omnirad EDB”, “Omnirad EHA”, “Esacure A198”, and “Omnipol ASA” manufactured by IGM RESINS B. V.: “SPEEDCURE EDB”, “SPEEDCURE EHA”, “SPEEDCURE BEDB”, and “SPEEDCURE 7040” manufactured by Lambson; and “GENOPOL AB-1” and “GENOPOL AB-2” manufactured by Rahn AG.

In the inkjet ink of the present embodiment, the aminobenzoate-based compounds listed above may be used singly or in combination of two or more types thereof.

When the inkjet ink of the present embodiment contains an aminobenzoate-based compound, the blending amount thereof is preferably 0.2 to 8% by mass, and particularly preferably 0.5 to 5% by mass with respect to the total mass of the inkjet ink.

### (Ketocoumarin-Based Compound)

Specific examples of the ketocoumarin-based compound include 3-benzoyl-7-methoxycoumarin, 3-benzoyl-5,7-dimethoxycoumarin, 3-(4-tert-butylbenzoyl)-5,7-dimethoxycoumarin, 3-(4-hexylbenzoyl)-5,7-dimethoxycoumarin, 3-[4-(2-ethylhexyl)benzoyl]-5,7-dimethoxycoumarin, 5,7-dimethoxy-3-[4-(3,5,5-trimethylhexyl)benzoyl] coumarin, 7-methoxy-3-(4-methylbenzoyl) coumarin, 7-methoxy-3-(4-tert-butylbenzoyl) coumarin, 7-methoxy-3-(4-hexylbenzoyl) coumarin, and 7-methoxy-3-[4-(2-ethylhexyl)benzoyl] coumarin.

The ketocoumarin-based compounds listed above are preferably used in combination with the acylphosphine oxide-based compound described above from the viewpoint of particularly improving curability. In particular, as the acylphosphine oxide-based compound, it is preferable to use at least one selected from the group consisting of ethoxyphenyl (2,4,6-trimethylbenzoyl) phosphine oxide and a multimer of the ethoxyphenyl (2,4,6-trimethylbenzoyl) phosphine oxide.

When the inkjet ink of the present embodiment contains a ketocoumarin-based compound, the blending amount thereof is preferably 1 to 10% by mass, and particularly preferably 2 to 8% by mass with respect to the total mass of the inkjet ink.

### (Other Photopolymerization Initiator)

Examples of a commercially available product of a photopolymerization initiator other than an acylphosphine oxide-based compound, a thioxanthone-based compound, and a ketocoumarin-based compound (also referred to as “other photopolymerization initiator” in the present specification) are described below.

Examples of a commercially available product of a benzophenone-based compound include “Omnirad BP”, “Omnirad BMS”, “Omnirad 4PBZ”, “OMNIRAD EMK”, and “Esacure 1001M” manufactured by IGM RESINS B. V.

Examples of a commercially available product of an indane-based compound include “SpeedCure XFs01” manufactured by LAMBSON.

Examples of a commercially available product of the hydroxyacetophenone-based compound include “Omnirad 127”, “Omnirad 184”, “Omnirad 1173”, “Omnirad 2959”, and “Esacure KIP150” manufactured by IGM RESINS B.V.

Examples of a commercially available product of the alkylaminoacetophenone-based compound include “Omnirad 907”, “Omnirad 369”, and “Omnirad 379” manufactured by IGM RESINS B.V.

Examples of a commercially available product of the oxime ester-based initiator include “IRGACURE OXE01”, “IRGACURE OXE02”, and “IRGACURE OXE04” manufactured by BASF.

Examples of a commercially available product of the anthracene-based compound include “Anthracure UVS-581” manufactured by Kawasaki Kasei Chemical Industry Co., Ltd.

In addition to those listed above, as a photopolymerization initiator, for example, “Omnirad 651” and “Omnirad MBF” manufactured by IGM RESINS B.V. can be used.

When the inkjet ink of the present embodiment contains a photopolymerization initiator, the total blending amount of the photopolymerization initiators is preferably 3 to 20% by mass, more preferably 4 to 17% by mass, and particularly preferably 5 to 15% by mass with respect to the total mass of the inkjet ink. By setting the total blending amount of the photopolymerization initiators within the above range, both curability and discharge stability can be achieved.

### <Other Components>

The inkjet ink of the present embodiment can use, in addition to the above-described components, a surface additive, a polymerization inhibitor, an organic solvent, water, an inert resin, and other additives in combination as necessary.

### (Surface Additive)

The inkjet ink of the present embodiment preferably contains a surface additive for the purpose of improving wet-spreadability to a printing substrate, print quality including fineness of a printed matter, substrate adhesion, and discharge stability. As the surface additive, for example, a siloxane-based surface additive, a fluorine-based surface additive, an acetylene glycol-based surface additive, or an acetylene monool-based surface additive can be used. Among these surface additives, it is preferable to use a siloxane-based surface additive from the viewpoint of being able to improve wet-spreadability to a printing substrate, print quality including fineness of a printed matter, substrate adhesion, and discharge stability without deteriorating dispersion stability of carbon black.

As the siloxane-based surface additive, for example, a compound having a dimethylsiloxane structure and/or a modified product thereof can be used. Among these compounds, a polyether-modified siloxane-based surface additive can be particularly preferably used. By using the polyether-modified siloxane-based surface additive, ink that impacts on a printing substrate can be sufficiently wet-spread without inhibiting the effect of 5-methyl-3-vinyloxazolidin-2-one. This makes it possible to achieve all of curability, print quality including fineness of a printed matter, and substrate adhesion while maintaining discharge stability and dispersion stability of carbon black in a preferable state.

Specific examples of the polyether group include a polyethylene oxide group and a polypropylene oxide group. Only one or both of these groups may be contained in a molecule as the polyether group.

Preferable examples of a commercially available product of the polyether-modified siloxane-based surface additive include BYK (registered trademark)-378, 348, 349, 3420, and 3760, BYK-UV3500, and UV3510 manufactured by BYK Japan KK; and TEGO (registered trademark) Glide 450, 440, 435, 432, 410, 406, 130, 110, and 100 manufactured by EVONIK.

When a siloxane-based surface additive is used, the content thereof is preferably 0.1 to 5.0% by mass with respect to the total mass of the inkjet ink. By adjusting the content to 0.1% by mass or more, wet-spreadability to a printing substrate is improved, and print quality including fineness of a printed matter and adhesion are also improved. Meanwhile, by adjusting the content to 5.0% by mass or less, curability, dispersion stability of carbon black, and discharge stability are easily ensured.

### (Polymerization Inhibitor)

In order to improve discharge stability of the inkjet ink, and improve hue stability and prevent curing wrinkles in a printed matter, a polymerization inhibitor can be blended in the inkjet ink of the present embodiment. Specific examples of the polymerization inhibitor include a hindered phenol-based compound, a phenol-based compound, a hydroquinone-based compound, a phenothiazine-based compound, a phosphorus-based compound, and a nitrosophenylhydroxylamine-based compound, and these compounds can be preferably used.

More specific examples of a polymerization inhibitor that can be used in the inkjet ink of the present embodiment include 4-methoxyphenol, tert-butylhydroquinone, 2,6-di-tert-butyl-4-methylphenol, pentaerythritol tetrakis[3-(3,5-di-tert-butyl-4-hydroxyphenyl) propionate], hydroquinone, methylhydroquinone, phenothiazine, dicumylphenothiazine, triphenylphosphine, and an aluminum salt of N-nitrosophenylhydroxylamine.

The content of the polymerization inhibitor is preferably 0.01 to 2% by mass, more preferably 0.05 to 1% by mass, and particularly preferably 0.1 to 0.8% by mass with respect to the total mass of the inkjet ink. When the content of the polymerization inhibitor is adjusted within the above range, it is easy to improve discharge stability of the inkjet ink while maintaining curability.

### (Organic Solvent and Water)

In the inkjet ink of the present embodiment, an organic solvent and/or water may be used for reducing the viscosity of the inkjet ink, improving wet-spreadability and adhesion to a printing substrate, and ensuring discharge stability. When the inkjet ink contains an organic solvent and/or water, the content thereof is preferably 0.01 to 20% by mass, more preferably 0.05 to 10% by mass, and particularly preferably 0.1 to 5% by mass with respect to the total mass of the inkjet ink. In addition, when an organic solvent is used, it is preferable to use an organic solvent having a boiling point of 140 to 300° C. from the viewpoint of discharge stability, and wet-spreadability and adhesion to a printing substrate.

As the organic solvent, for example, alkylene glycol monoalkyl ether acetates, alkylene glycol diacetates, alkylene glycol monoalkyl ethers, alkylene glycol dialkyl ethers, alkanediols, lactams, lactones, other nitrogen-containing solvents, and other oxygen-containing solvents can be used.

Among these organic solvents, it is preferable to contain at least one selected from the group consisting of alkylene glycol monoalkyl ethers, alkylene glycol dialkyl ethers, and alkylene glycol monoalkyl ether acetates. In particular, tripropylene glycol monomethyl ether, dipropylene glycol monomethyl ether, propylene glycol monomethyl ether, ethylene glycol monobutyl ether, diethylene glycol monobutyl ether, triethylene glycol monobutyl ether, tetraethylene glycol dialkyl ether, ethylene glycol monobutyl ether acetate, and diethylene glycol diethyl ether are preferable. In an embodiment, the organic solvent preferably contains at least one selected from the group consisting of tetraethylene glycol dialkyl ether, ethylene glycol monobutyl ether acetate, and diethylene glycol diethyl ether.

### (Inert Resin)

The inkjet ink of the present embodiment may contain an inert resin for the purpose of imparting adhesion to various printing substrates and adjusting viscoelasticity of the ink to improve discharge stability. As the inert resin, a (meth)acrylic resin, a urethane resin, a vinyl chloride-vinyl acetate copolymer resin, a ketone resin, and the like can be used. Among these resins, the inert resin preferably contains a (meth)acrylic resin and/or a ketone resin from the viewpoint of being able to improve both adhesion and discharge stability.

When the inkjet ink of the present embodiment contains an inert resin, the content thereof is preferably 0.1 to 10% by mass, more preferably 0.5 to 5% by mass, and particularly preferably 1 to 3% by mass with respect to the total mass of the inkjet ink. When the content is adjusted within the above range, adhesion and discharge stability can be easily improved without deteriorating curability.

In the present specification, the “inert resin” refers to a resin that is not involved in a polymerization reaction and contributes to adhesion to a printing substrate, and has solubility in the inkjet ink.

### (Other Additive)

The inkjet ink of the present embodiment may further contain an additive such as an ultraviolet absorber or a fading inhibitor in addition to the above-described components as necessary. As these components, conventionally known compounds can be arbitrarily used.

### <Physical Properties of Inkjet Ink>

A viscosity of the inkjet ink of the present embodiment at 25° C. is preferably 5 to 25 mPa·s, and more preferably 8 to 20 mPa·s from the viewpoint of improving discharge stability. When the viscosity is 5 mPa·s or more, the inkjet ink can be favorably discharged from an inkjet head. When the viscosity is 25 mPa·s or less, discharge can be stably continued without deteriorating discharge accuracy. The viscosity is particularly preferably 8 to 14 mPa·s from the viewpoint that high frequency suitability can be imparted and the ink can be stably discharged even in high-speed printing. The viscosity can be measured using 1.1 mL of the inkjet ink and an E-type viscometer equipped with a cone (diameter: 48 mm) having a cone angle of 1°34′ (for example, “TVE25L” manufactured by Toki Sangyo Co., Ltd.) under an environment of 25° C. and under a rotation speed condition of 20 rpm.

Static surface tension of the inkjet ink at 25° C. is preferably 20 to 45 mN/m, and particularly preferably 22 to 40 mN/m from the viewpoint of improving all of discharge stability, fineness of a printed matter, and curability. As the static surface tension, a value measured by a plate method (Wilhelmy method) is used. Specifically, for example, measurement can be performed under an environment of 25° C. using an automatic surface tensiometer “CBVP-Z” manufactured by Kyowa Interface Science Co., Ltd. and a platinum plate.

### <Method for Manufacturing Inkjet Ink>

The inkjet ink of the present embodiment can be manufactured by a conventionally known method. For example, the inkjet ink can be manufactured as follows, but a method for manufacturing the inkjet ink of the present embodiment is not limited to the method described below.

First, a basic pigment dispersing resin is dissolved in a polymerizable compound in advance to manufacture a basic pigment dispersing resin varnish. Next, carbon black satisfying the above-described requirements is added little by little to the basic pigment dispersing resin varnish being stirred, and mixed. The mixture is mixed for a certain period of time, and then a dispersion treatment is performed using a dispersing apparatus such as a paint shaker, a sand mill, a roll mill, or a media-less disperser, thereby manufacturing a carbon black dispersion. Note that it is preferable to use a radically polymerizable bifunctional monomer and/or a radically polymerizable trifunctional monomer as the polymerizable compound to be used in manufacture of the basic pigment dispersing resin varnish, and it is particularly preferable to use a radically polymerizable bifunctional monomer represented by the general formula (A) and/or a radically polymerizable trifunctional monomer represented by the general formula (B) from the viewpoint of improving dispersion stability of carbon black.

Thereafter, to the carbon black dispersion, 5-methyl-3-vinyloxazolidin-2-one, and if necessary, a photopolymerization initiator, a surface additive, a polymerization inhibitor, an organic solvent, water, an inert resin, another additive, and the like are added and mixed well. Then, by filtering the mixture with a filter and the like to filter out coarse particles, the inkjet ink of the present embodiment can be obtained.

The amount of carbon black present in the carbon black dispersion is preferably 10 to 50% by mass, more preferably 12 to 40% by mass, and particularly preferably 15 to 30% by mass in the carbon black dispersion.

### <Inkjet Printing Method>

The inkjet ink of the present embodiment described above is preferably used in an inkjet printing method. In addition, the inkjet printing method preferably includes a step (step I) of discharging the inkjet ink of the present embodiment from an inkjet head onto a printing substrate, and a step (step II) of irradiating the inkjet ink discharged onto the printing substrate with an active energy ray to cure the inkjet ink in this order.

In the inkjet printing method, a method for discharging and applying the same inkjet ink from the same inkjet head to the same place on a printing substrate a plurality of times, that is, a method for performing the above step I on the same place on the printing substrate a plurality of times (multi-pass printing method) may be adopted. However, in a case of the inkjet printing method using the inkjet ink of the present embodiment, a method for discharging and applying the same inkjet from the same inkjet head to the same place on a printing substrate only once is preferable from the viewpoint that the effect of the inkjet ink, which is excellent in curability and discharge stability, is sufficiently exhibited and a printed matter can be obtained at a high speed and stably. That is, it is preferable to adopt a method in which the step I is performed only once on the same position on the printing substrate (one-pass printing method).

The one-pass printing method can be performed by using, for example, a line printer. A printing speed (transport speed of a printing substrate) at this time is preferably 35 to 150 m/min, more preferably 50 to 125 m/min, and still more preferably 75 to 100 m/min from the viewpoint of obtaining a printed matter having productivity and favorable quality.

The inkjet ink of the present embodiment is an ink for inkjet printing. Therefore, as described above, an inkjet head is used as an inkjet ink discharging means in the step I.

Examples of a method for discharging an ink using the inkjet head include an electrostatic induction method in which an ink is discharged using electrostatic force, a drop-on-demand method (pressure pulse method) in which vibration pressure of a piezoelectric element is used, an acoustic inkjet method in which an ink is irradiated with an acoustic beam converted from an electric signal, and the ink is discharged using radiation pressure at this time, and a thermal inkjet method in which an ink is heated to form bubbles, and the ink is discharged using generated pressure. Among these methods, in an embodiment, a drop-on-demand method (pressure pulse method) using vibration pressure of a piezoelectric element can be preferably used from the viewpoint of discharge stability.

A drop volume of droplets of the inkjet ink discharged from an inkjet nozzle is preferably 1 to 50 pL (picoliter), more preferably 2 to 30 pL, and still more preferably 3 to 20 pL from the viewpoint of fineness of a printed matter and discharge stability. Design resolution of the inkjet head is preferably 300 dpi or more, more preferably 480 dpi or more, and still more preferably 600 dpi or more. Note that dpi represents the number of dots per 2.54 cm (1 inch).

Examples of the inkjet head satisfying the above conditions include KJ4A-AA, KJ4A-TA, and KJ4A-RH manufactured by KYOCERA Corporation, Samba G3L manufactured by FUJIFILM Corporation, S3200, S1600, S800, 13200, and I1600 manufactured by Seiko Epson Corporation, KM1024i and KM1024 manufactured by KONICA MINOLTA, Inc., and MH5320, MH5340, MH5240, and MH5440 manufactured by Ricoh Co., Ltd., all of which can be preferably used.

In an embodiment, the inkjet ink can be discharged while being heated by a heating device such as a heater included in the inkjet head such that the inkjet ink has an appropriate viscosity. The inkjet ink is preferably heated such that the viscosity of the inkjet ink at the time of discharge is 15 mPa·s or less, and the inkjet ink is more preferably heated such that the viscosity of the inkjet ink at the time of discharge is 12 mPa's or less from the viewpoint of stably discharging the inkjet ink continuously.

Meanwhile, in the step II, the inkjet ink discharged onto the printing substrate is cured by being irradiated with an active energy ray, and a cured film (printed matter) is formed. That is, a printed matter having a cured film of the inkjet ink is formed on the printing substrate.

The “active energy ray” in the present specification represents an energy ray capable of providing energy necessary for generating active species such as radicals, cations, and anions in an irradiated body (inkjet ink). Specific examples of the active energy ray include an ultraviolet ray, an electron beam, a visible ray, and an infrared ray, and it is preferable to select an ultraviolet ray from the viewpoint that curability of the inkjet ink can be easily improved and the viewpoint that design flexibility of the inkjet ink and a printing apparatus is high.

Examples of a light source of the ultraviolet ray include a high-pressure mercury lamp, a low-pressure mercury lamp, an ultra high-pressure mercury lamp, a metal halide lamp, an ultraviolet laser, and an LED lamp, and only one of these may be used, or two or more thereof may be used in combination. For example, since the LED lamp has a small shape, it is easy to arrange a plurality of the LED lamps side by side or to use the LED lamp together with a high-pressure mercury lamp or a metal halide lamp, and curability can be further improved easily. When a plurality of LED lamps are arranged side by side, a plurality of types of LED lamps having different radiation peak wavelengths may be used in combination.

In general, an ultraviolet ray emitted from the LED lamp has a narrow wavelength width, and the ultraviolet ray is excellent in rectilinearity (that is, poor in diffusibility). Therefore, the ultraviolet ray tends to have difficulty in curing the active energy ray-curable inkjet ink. In particular, in a case of an inkjet ink containing carbon black, curing with the LED lamp is difficult for the reasons described above, that is, that an ultraviolet ray is absorbed by the carbon black and a quinone group on a surface of the carbon black may trap radicals. However, the inkjet ink of the present embodiment is particularly excellent in curability, and thus can be preferably combined with the LED lamp.

In the inkjet printing method using the inkjet ink of the present embodiment, it is preferable to select an ultraviolet ray as the active energy ray. When an LED lamp is adopted as a light source of the ultraviolet ray, a radiation peak wavelength thereof is preferably 260 to 450 nm, more preferably 280 to 420 nm, and particularly preferably 320 to 410 nm.

When an LED lamp that emits an ultraviolet ray is used in the step II, maximum intensity of the ultraviolet ray on a printing substrate is preferably 1,000 mW/cm² or more from the viewpoint of sufficiently exhibiting the above-described effects and obtaining a printed matter excellent in curability and print quality including fineness of a printed matter. The maximum intensity is more preferably 2,000 mW/cm² or more, and particularly preferably 3,000 mW/cm² or more. In addition, an integrated light intensity at the time of irradiating the printing substrate can be adjusted by the types and contents of a polymerizable compound and a photopolymerization initiator contained in the inkjet ink. For example, the integrated light intensity is preferably 50 mJ/cm² or more. The integrated light intensity is more preferably 100 mJ/cm² or more, and particularly preferably 150 mJ/cm² or more.

In the step I, after droplets of the inkjet ink are attached to the printing substrate (that is, after end of the step I), irradiation with an active energy ray is started (that is, step II is started). A time from the end of the step I to start of the step II is preferably adjusted to 0.03 to 3 seconds. The time is more preferably 0.04 to 2.5 seconds, and still more preferably 0.6 to 2 seconds. By adjusting the time within the above range, dot formability of the inkjet ink is improved, and a printed matter excellent in fineness of a printed matter can be obtained.

In the inkjet printing method, the step II can be repeated a plurality of times. For example, immediately after the inkjet ink is applied onto the printing substrate, the inkjet ink is irradiated with an active energy ray to partially cure the inkjet ink, and then the inkjet ink is irradiated with the active energy ray again to completely cure the inkjet ink. In this way, it is easy to obtain a printed matter particularly excellent in print quality including fineness of a printed matter. In the present specification, the step of partially curing the inkjet ink described above is referred to as “temporary curing”. The step of completely curing the inkjet ink is referred to as “full curing”.

That is, in an embodiment, the inkjet printing method using the inkjet ink of the present embodiment may include a step (step I) of discharging the inkjet ink from an inkjet head onto a printing substrate, a step (step II-A) of irradiating the inkjet ink, which has been discharged onto the printing substrate with an active energy ray to temporarily cure the inkjet ink, and a step (step II-B) of fully curing the inkjet ink in this order.

When the step II-A is performed, that is, when the inkjet ink discharged onto the printing substrate is temporarily cured, it is preferable to use an LED lamp that emits an ultraviolet ray. In this case, the maximum intensity of the ultraviolet ray on the printing substrate in the temporary curing is preferably 2 to 20 mW/cm², and more preferably 5 to 15 mW/cm² from the viewpoint of particularly improving print quality including fineness of a printed matter.

When the step II-B is performed, that is, when the inkjet ink discharged onto the printing substrate is fully cured, an LED lamp that emits an ultraviolet ray can also be used. In this case, it is preferable to perform the step II-B at the maximum intensity of 1,000 mW/cm² or more and the integrated light intensity of 50 mJ/cm² or more described above.

Meanwhile, in the step II-B, an ultraviolet ray can be emitted using a high-pressure mercury lamp or a metal halide lamp. In this case, the maximum intensity of the ultraviolet ray is preferably 80 mW/cm² or more, and more preferably 120 mW/cm² or more. In addition, the integrated light intensity is preferably 100 mJ/cm² or more, more preferably 150 mJ/cm² or more, and still more preferably 200 mJ/cm² or more.

### <Printing Substrate>

The printing substrate used in the printing method using the inkjet ink of the present embodiment is preferably a resin film substrate or a paper substrate. The resin film substrate may preferably have a thickness of 10 to 90 μm. As the resin film substrate, a substrate containing a material selected from the group consisting of polypropylene, polyethylene, polyethylene terephthalate, and nylon is preferably selected. As the paper substrate, standard coated paper, art paper, laminated paper, and the like are preferably selected. In an embodiment, the inkjet ink of the present embodiment is preferably used for printing packages formed by the printing substrates listed above. In the printing of packages, the inkjet ink of the present embodiment is particularly preferably used for printing of a food package.

Note that the “substrate containing a material selected from the group consisting of polypropylene, polyethylene, polyethylene terephthalate, and nylon” is not limited to a single layer structure, and may have a multilayer structure. That is, the substrate may be, for example, a resin film substrate having one layer made from at least one material selected from the group consisting of polyethylene terephthalate, polyethylene, polypropylene, and nylon. As another example, the substrate may be a resin film substrate (laminated film substrate) having two or more of the layers. In addition, for the purpose of improving strength of a package, blocking oxygen, and the like, a layer including an AL (aluminum foil), a VM (vacuum vapor-deposited) film (aluminum vapor-deposited film or transparent vapor-deposited film), and the like may be formed in layers forming the laminated film substrate.

### <Printed Matter>

The inkjet ink of the present embodiment can be used for manufacturing a printed matter (printing substrate on which printing information is recorded). In addition, the inkjet printing method described above can be used as a method for manufacturing the printed matter.

### EXAMPLES

Hereinafter, the present invention will be described in more detail, but the following Examples do not limit the scope of rights of the present invention at all. Unless otherwise specified, “parts” represents parts by mass, and “%” represents % by mass.

### <Raw Materials Used>

In Examples described below, carbon blacks presented in Table 1 below were used. Note that, in Table 3 described later, the carbon blacks used are listed in abbreviated forms.

TABLE 1

| | | | DBP oil | Specific | | | Primary |
|---|---|---|---|---|---|---|---|
| | | | absorption | surface | | | particle |
| | | | amount (AC) | area (SC) | | | size |
| Product name | Abbreviation | Manufacturer | (mL/100 g) | (m²/g) | AC × SC | pH | (nm) |
| Special Black 250 | SB250 | Orion | 45 | 48 | 2,160 | 3.5 | 47 |
| Special Black 350 | SB350 | Engineered | 43 | 62 | 2,666 | 3.5 | 31 |
| Special Black 550 | SB550 | Carbons | 49 | 112 | 5,488 | 4 | 25 |
| NEROX 555 | NE555 | | 75 | 94 | 7,050 | 2.5 | 26 |
| NEROX 500 | NE500 | | 110 | 114 | 12,540 | 2.5 | 23 |
| PrinteX 95 | PX95 | | 52 | 250 | 13,000 | 9.5 | 15 |
| NiPex 150 | NP150 | | 120 | 175 | 21,000 | 4 | 25 |
| #85 | #85 | Mitsubishi | 48 | 60 | 2,880 | 7.5 | 40 |
| #52 | #52 | Chemical | 63 | 88 | 5,544 | 8 | 27 |
| #850 | #850 | Corporation | 77 | 220 | 16,940 | 8 | 17 |
| MA100 | MA100 | | 100 | 110 | 11,000 | 3.5 | 24 |

In Examples described below, pigment dispersing resins presented in Table 2 below were used. Note that, in Table 3 described later, the pigment dispersing resins used are listed in abbreviated forms. Among the pigment dispersing resins presented in Table 2 below, pigment dispersing resins excluding Solsperse41000 are basic pigment dispersing resins, and the Solsperse41000 is an acidic pigment dispersing resin (pigment dispersing resin in which an adsorption point with a pigment is an acid group).

TABLE 2

| | | | Acid | Amine |
|---|---|---|---|---|
| | Abbre- | | value | value |
| Product name | viation | Manufacturer | (mgKOH/g) | (mgKOH/g) |
| Solsperse32000 | S32000 | The Lubrizol | 16 | 35 |
| Solsperse33000 | S33000 | Corporation | 26 | 43 |
| Solsperse86000 | S86000 | | 26 | 51 |
| Solsperse41000 | S41000 | | 50 | 0 |
| DISPERBYK- | B2013 | BYK Japan | 8 | 18 |
| 2013 | | KK | | |
| DISPERBYK- | B2155 | | 0 | 48 |
| 2155 | | | | |
| BYKJET-9150 | B9150 | | 5 | 12 |
| BYKJET-9151 | B9151 | | 8 | 18 |
| DISPERBYK-180 | B180 | | 94 | 94 |
| AJISPER PB821 | PB821 | Ajinomoto | 17 | 10 |
| AJISPER PB822 | PB822 | Fine-Techno | 14 | 17 |
| | | Co., Inc. | | |

### <Manufacture of Carbon Black Dispersion>

Each of carbon black dispersions 1 to 27 was manufactured using raw materials described in each column of Table 3 below. Specifically, first, a pigment dispersing resin and a polymerizable compound were charged into a mixing container (volume: 8 L) equipped with a stirrer, and stirred (pre-mixed) for one hour to manufacture a pigment dispersing resin varnish. Next, carbon black was added little by little to the pigment dispersing resin varnish being stirred, and after completion of the addition, stirring was further continued for one hour (preliminary dispersion). Thereafter, circulation dispersion of the mixture was performed over two hours using “DYNO-MILL” (volume: 0.6 L) manufactured by SHINMARU ENTERPRISES CORPORATION filled with zirconia beads having a diameter of 0.8 mm such that a filling ratio was 70%, thereby manufacturing a carbon black dispersion.

TABLE 3

| Carbon black dispersion No. | | | 1 | 2 | 3 | 4 | 5 | 6 | 7 | 8 | 9 | 10 | 11 |
|---|---|---|---|---|---|---|---|---|---|---|---|---|---|
| Pigment | Pigment | Type | S32000 | S32000 | S32000 | S32000 | S32000 | S32000 | S32000 | S32000 | S32000 | S32000 | S32000 |
| dispersing | dispersing resin | Amount [g] | 113 | 113 | 113 | 113 | 113 | 113 | 113 | 113 | 113 | 113 | 113 |
| resin varnish | Polymerizable | Type | HDDA | HDDA | HDDA | HDDA | HDDA | HDDA | HDDA | HDDA | HDDA | HDDA | HDDA |
| | compound | Amount [g] | 2437 | 2437 | 2437 | 2437 | 2437 | 2437 | 2437 | 2437 | 2437 | 2437 | 2437 |

| Carbon black | Type | SB250 | SB350 | SB550 | NE555 | #85 | #52 | MA100 | NE500 | PX95 | NP150 | #850 |
|---|---|---|---|---|---|---|---|---|---|---|---|---|
| | Amount [g] | 450 | 450 | 450 | 450 | 450 | 450 | 450 | 450 | 450 | 450 | 450 |

| | | | | | | | | | | | |
|---|---|---|---|---|---|---|---|---|---|---|---|
| Secondary particle size [nm] | 155 | 150 | 140 | 145 | 185 | 180 | 120 | 125 | 160 | 110 | 155 |
| Content of pigment dispersing | 25% | 25% | 25% | 25% | 25% | 25% | 25% | 25% | 25% | 25% | 25% |
| resin to content of carbon black | | | | | | | | | | | |

| Carbon black dispersion No. | | | 12 | 13 | 14 | 15 | 16 | 17 | 18 | 19 | 20 | 21 |
|---|---|---|---|---|---|---|---|---|---|---|---|---|
| Pigment | Pigment | Type | S33000 | S86000 | B2013 | B2155 | B9150 | B9151 | PB821 | PB822 | S41000 | B180 |
| dispersing | dispersing resin | Amount [g] | 113 | 113 | 113 | 113 | 113 | 113 | 113 | 113 | 113 | 113 |
| resin varnish | Polymerizable | Type | HDDA | HDDA | HDDA | HDDA | HDDA | HDDA | HDDA | HDDA | HDDA | HDDA |
| | compound | Amount [g] | 2437 | 2437 | 2437 | 2437 | 2437 | 2437 | 2437 | 2437 | 2437 | 2437 |

| Carbon black | Type | SB350 | SB350 | SB350 | SB350 | SB350 | SB350 | SB350 | SB350 | SB350 | SB350 |
|---|---|---|---|---|---|---|---|---|---|---|---|
| | Amount [g] | 450 | 450 | 450 | 450 | 450 | 450 | 450 | 450 | 450 | 450 |

| | | | | | | | | | | |
|---|---|---|---|---|---|---|---|---|---|---|
| Secondary particle size [nm] | 160 | 155 | 140 | 155 | 165 | 150 | 150 | 155 | 190 | 180 |
| Content of pigment dispersing | 25% | 25% | 25% | 25% | 25% | 25% | 25% | 25% | 25% | 25% |
| resin to content of carbon black | | | | | | | | | | |

| Carbon black dispersion No. | | | 22 | 23 | 24 | 25 | 26 | 27 |
|---|---|---|---|---|---|---|---|---|
| Pigment | Pigment | Type | S32000 | S32000 | B9151 | B9151 | B9151 | B9151 |
| dispersing | dispersing resin | Amount [g] | 113 | 113 | 50 | 90 | 220 | 310 |
| resin varnish | Polymerizable | Type | DPGDA | NDDA | HDDA | HDDA | HDDA | HDDA |
| | compound | Amount [g] | 2437 | 2437 | 2500 | 2460 | 2330 | 2240 |

| Carbon black | Type | SB350 | SB350 | SB350 | SB350 | SB350 | SB350 |
|---|---|---|---|---|---|---|---|
| | Amount [g] | 450 | 450 | 450 | 450 | 450 | 450 |

| | | | | | | |
|---|---|---|---|---|---|---|
| Secondary particle size [nm] | 155 | 165 | 175 | 155 | 160 | 170 |
| Content of pigment dispersing | 25% | 25% | 11% | 20% | 49% | 69% |
| resin to content of carbon black | | | | | | |

Note that Table 3 also describes a secondary particle size and the content of a pigment dispersing resin relative to the content of carbon black in each of the carbon black dispersions 1 to 27 manufactured using the above-described method. Details of the abbreviations used in Table 3 are as follows. Abbreviations not described below are as described above in Tables 1 and 2.
HDDA: 1,6-hexanediol diacrylate
DPGDA: dipropylene glycol diacrylate
NDDA: 1,9-nonanediol diacrylate

### <Manufacture of Inkjet Ink>

Materials described in each column of Table 4 below were charged into a mixing container equipped with a stirrer. After all the materials were charged, the mixture was heated while being stirred until the temperature of the mixture reached 40° C., and after the temperature reached 40° C., stirring was further continued for one hour while the temperature was maintained. Thereafter, filtration was performed with a membrane filter having a pore size of 0.8 μm to manufacture each of inkjet inks 1 to 96.

Note that, in the manufacture of the inkjet inks, the materials were charged while the mixture in the mixing container was stirred. In addition, the materials were charged in order of a carbon black dispersion, a polymerizable compound other than 5-methyl-3-vinyloxazolidin-2-one, 5-methyl-3-vinyloxazolidin-2-one, a photopolymerization initiator, a polymerization initiator, and a surface additive. Note that, when an inkjet ink not containing one or more of these components was manufactured, the component was not charged, and a subsequent component was charged according to the order. In addition, regarding a component containing two or more types of materials, the charging order in the component was a descending order of addition amount.

TABLE 4

| | | | | Example / Comparative Example | | | | | | | | |
|---|---|---|---|---|---|---|---|---|---|---|---|---|
| | | | | | | | | | | | Comparative | Comparative |
| | | | | Example 1 | Example 2 | Example 3 | Example 4 | Example 5 | Example 6 | Example 7 | Example 1 | Example 2 |
| Inkjet ink No. | | | | 1 | 2 | 3 | 4 | 5 | 6 | 7 | 8 | 9 |
| Content | Carbon black | Carbon black dispersion No. used | | 1 | 2 | 3 | 4 | 5 | 6 | 7 | 8 | 9 |
| | dispersion | Blending amount | | 18 | 18 | 18 | 18 | 18 | 18 | 18 | 18 | 18 |
| | Polymerizable | Radically | PDDA | | | | | | | | | |
| | compound | polymerizable | BDDA | | | | | | | | | |
| | | bifunctional | MPDDA | | | | | | | | | |
| | | monomer | HDDA | 30 | 30 | 30 | 30 | 30 | 30 | 30 | 30 | 30 |
| | | represented by | | | | | | | | | | |
| | | general formula | | | | | | | | | | |
| | | (A) | | | | | | | | | | |
| | | Radically | GlyTA | 5 | 5 | 5 | 5 | 5 | 5 | 5 | 5 | 5 |
| | | polymerizable | Gly(EO)3TA | | | | | | | | | |
| | | trifunctional | Gly(EO)9TA | | | | | | | | | |
| | | monomer | | | | | | | | | | |
| | | represented by | | | | | | | | | | |
| | | general formula | | | | | | | | | | |
| | | (B) | | | | | | | | | | |
| | | Other | CHA | | | | | | | | | |
| | | monofunctional | IBXA | | | | | | | | | |
| | | monomer | BzA | | | | | | | | | |
| | | | VCL | | | | | | | | | |
| | | Other | NDDA | | | | | | | | | |
| | | bifunctional | DPGDA | 13 | 13 | 13 | 13 | 13 | 13 | 13 | 13 | 13 |
| | | monomer | PEG400DA | | | | | | | | | |
| | | Other | TMP(EO)3TA | | | | | | | | | |
| | | trifunctional | TMP(PO)2TA | | | | | | | | | |
| | | monomer | | | | | | | | | | |
| | | MVOZ | | 20 | 20 | 20 | 20 | 20 | 20 | 20 | 20 | 20 |
| | Photo- | Acylphosphine | TPO-L | 7.5 | 7.5 | 7.5 | 7.5 | 7.5 | 7.5 | 7.5 | 7.5 | 7.5 |
| | polymerization | oxide compound | OmnTP | | | | | | | | | |
| | initiator | | Omn819 | 3 | 3 | 3 | 3 | 3 | 3 | 3 | 3 | 3 |
| | | Thioxanthone | DETX | 3 | 3 | 3 | 3 | 3 | 3 | 3 | 3 | 3 |
| | | compound | OmnTX | | | | | | | | | |
| | | Alkylaminoaceto- | Omn379 | | | | | | | | | |
| | | phenone compound | | | | | | | | | | |
| | | Benzoaminoate | ASA | | | | | | | | | |
| | | compound | | | | | | | | | | |

| | | | | | | | | | | | |
|---|---|---|---|---|---|---|---|---|---|---|---|
| | Polymerization | BHT | 0.1 | 0.1 | 0.1 | 0.1 | 0.1 | 0.1 | 0.1 | 0.1 | 0.1 |
| | inhibitor | | | | | | | | | | |
| | Surface additive | UV3510 | 0.4 | 0.4 | 0.4 | 0.4 | 0.4 | 0.4 | 0.4 | 0.4 | 0.4 |
| Specifications | Specification of | DBP oil absorption amount (AC) | 45 | 43 | 49 | 75 | 48 | 63 | 100 | 110 | 52 |
| | carbon black | [mL/100 g] | | | | | | | | | |
| | | Specific surface area (SC) | 48 | 62 | 112 | 94 | 60 | 88 | 110 | 114 | 250 |
| | | [m²/g] | | | | | | | | | |
| | | AC × SC | 2160 | 2666 | 5488 | 7050 | 2880 | 5544 | 11000 | 12540 | 13000 |
| | | pH | 3.5 | 3.5 | 4 | 2.5 | 7.5 | 8 | 3.5 | 2.5 | 9.5 |
| | | Primary particle size (nm) | 47 | 31 | 25 | 26 | 40 | 27 | 24 | 23 | 15 |
| | Specification of | Acid value [mgKOH/g] | 16 | 16 | 16 | 16 | 16 | 16 | 16 | 16 | 16 |
| | pigment dispersing | Amine value [mgKOH/g] | 35 | 35 | 35 | 35 | 35 | 35 | 35 | 35 | 35 |
| | resin | | | | | | | | | | |
| | Content | Amount of carbon black | 2.7 | 2.7 | 2.7 | 2.7 | 2.7 | 2.7 | 2.7 | 2.7 | 2.7 |
| | in inkjet ink | Amount of polymerizable | 82.6 | 82.6 | 82.6 | 82.6 | 82.6 | 82.6 | 82.6 | 82.6 | 82.6 |
| | | compound | | | | | | | | | |
| | | Amount of monofunctional | 0 | 0 | 0 | 0 | 0 | 0 | 0 | 0 | 0 |
| | | polymerizable compound | | | | | | | | | |
| | | (excluding MVOZ) | | | | | | | | | |
| | | Amount of bifunctional monomer | 44.6 | 44.6 | 44.6 | 44.6 | 44.6 | 44.6 | 44.6 | 44.6 | 44.6 |
| | | of general formula (A) | | | | | | | | | |
| | | Amount of trifunctional monomer | 5 | 5 | 5 | 5 | 5 | 5 | 5 | 5 | 5 |
| | | of general formula (B) | | | | | | | | | |
| | Ratio of content | Ratio of amount of bifunctional | 8.9 | 8.9 | 8.9 | 8.9 | 8.9 | 8.9 | 8.9 | 8.9 | 8.9 |
| | | monomer of general formula (A) | | | | | | | | | |
| | | to amount of trifunctional | | | | | | | | | |
| | | monomer of general formula (B) | | | | | | | | | |
| | | Ratio of amount of other | 3.1 | 3.1 | 3.1 | 3.1 | 3.1 | 3.1 | 3.1 | 3.1 | 3.1 |
| | | polymerizable compound to | | | | | | | | | |
| | | amount of MVOZ | | | | | | | | | |
| | | Ratio of amount of | 0.53 | 0.53 | 0.53 | 0.53 | 0.53 | 0.53 | 0.53 | 0.53 | 0.53 |
| | | acylphosphine oxide compound | | | | | | | | | |
| | | to amount of MVOZ | | | | | | | | | |
| | | Ratio of (total) content of TPO-L | 55.6% | 55.6% | 55.6% | 55.6% | 55.6% | 55.6% | 55.6% | 55.6% | 55.6% |
| | | and/or TP to total amount of | | | | | | | | | |
| | | photopolymerization initiator | | | | | | | | | |
| | | Ratio of amount of | 3.5 | 3.5 | 3.5 | 3.5 | 3.5 | 3.5 | 3.5 | 3.5 | 3.5 |
| | | acylphosphine oxide compound | | | | | | | | | |
| | | to amount of thioxanthone | | | | | | | | | |
| | | compound | | | | | | | | | |
| | | Ratio of amount of | 0.46 | 0.46 | 0.46 | 0.46 | 0.46 | 0.46 | 0.46 | 0.46 | 0.46 |
| | | acylphosphine oxide compound | | | | | | | | | |
| | | to sum of amount of MVOZ and | | | | | | | | | |
| | | amount of thioxanthone | | | | | | | | | |
| | | compound | | | | | | | | | |
| Evaluation | Evaluation 1 | Dispersion stability | 4 | 4 | 3 | 4 | 2 | 2 | 2 | 2 | 1 |
| results | Evaluation 2 | Discharge stability | 4 | 4 | 3 | 3 | 3 | 3 | 2 | 1 | Not |
| | | | | | | | | | | | performed |
| | Evaluation 3 | Curability | 3 | 4 | 4 | 3 | 4 | 4 | 3 | 3 | 3 |
| | Evaluation 4 | Fineness of printed matter | 4 | 4 | 4 | 4 | 4 | 4 | 3 | 3 | 2 |
| | | (character visibility) | | | | | | | | | |

| | | | Example / Comparative Example | | | | | | | |
|---|---|---|---|---|---|---|---|---|---|---|
| | | | Comparative | Comparative | | | | | | |
| | | | Example 3 | Example 4 | Example 8 | Example 9 | Example 10 | Example 11 | Example 12 | Example 13 |
| Inkjet ink No. | | | 10 | 11 | 12 | 13 | 14 | 15 | 16 | 17 |
| Content | Carbon black | Carbon black dispersion No. used | 10 | 11 | 12 | 13 | 14 | 15 | 16 | 17 |
| | dispersion | Blending amount | 18 | 18 | 18 | 18 | 18 | 18 | 18 | 18 |

| Polymerizable | Radically | PDDA | | | | | | | | |
|---|---|---|---|---|---|---|---|---|---|---|
| compound | polymerizable | BDDA | | | | | | | | |
| | bifunctional | MPDDA | | | | | | | | |
| | monomer | HDDA | 30 | 30 | 30 | 30 | 30 | 30 | 30 | 30 |
| | represented by | | | | | | | | | |
| | general formula | | | | | | | | | |
| | (A) | | | | | | | | | |
| | Radically | GlyTA | 5 | 5 | 5 | 5 | 5 | 5 | 5 | 5 |
| | polymerizable | Gly(EO)3TA | | | | | | | | |
| | trifunctional | Gly(EO)9TA | | | | | | | | |
| | monomer | | | | | | | | | |
| | represented by | | | | | | | | | |
| | general formula | | | | | | | | | |
| | (B) | | | | | | | | | |
| | Other | CHA | | | | | | | | |
| | monofunctional | IBXA | | | | | | | | |
| | monomer | BzA | | | | | | | | |
| | | VCL | | | | | | | | |
| | Other | NDDA | | | | | | | | |
| | bifunctional | DPGDA | 13 | 13 | 13 | 13 | 13 | 13 | 13 | 13 |
| | monomer | PEG400DA | | | | | | | | |
| | Other | TMP(EO)3TA | | | | | | | | |
| | trifunctional | TMP(PO)2TA | | | | | | | | |
| | monomer | | | | | | | | | |
| | MVOZ | | 20 | 20 | 20 | 20 | 20 | 20 | 20 | 20 |
| Photo- | Acylphosphine | TPO-L | 7.5 | 7.5 | 7.5 | 7.5 | 7.5 | 7.5 | 7.5 | 7.5 |
| polymerization | oxide compound | OmnTP | | | | | | | | |
| initiator | | Omn819 | 3 | 3 | 3 | 3 | 3 | 3 | 3 | 3 |
| | Thioxanthone | DETX | 3 | 3 | 3 | 3 | 3 | 3 | 3 | 3 |
| | compound | OmnTX | | | | | | | | |
| | Alkylaminoaceto- | Omn379 | | | | | | | | |
| | phenone compound | | | | | | | | | |
| | Benzoaminoate | ASA | | | | | | | | |
| | compound | | | | | | | | | |

| | | | | | | | | | | |
|---|---|---|---|---|---|---|---|---|---|---|
| | Polymerization | BHT | 0.1 | 0.1 | 0.1 | 0.1 | 0.1 | 0.1 | 0.1 | 0.1 |
| | inhibitor | | | | | | | | | |
| | Surface additive | UV3510 | 0.4 | 0.4 | 0.4 | 0.4 | 0.4 | 0.4 | 0.4 | 0.4 |
| Specifications | Specification of | DBP oil absorption amount (AC) | 120 | 77 | 43 | 43 | 43 | 43 | 43 | 43 |
| | carbon black | [mL/100 g] | | | | | | | | |
| | | Specific surface area (SC) | 175 | 220 | 62 | 62 | 62 | 62 | 62 | 62 |
| | | [m²/g] | | | | | | | | |
| | | AC × SC | 21000 | 16940 | 2666 | 2666 | 2666 | 2666 | 2666 | 2666 |
| | | pH | 4 | 8 | 3.5 | 3.5 | 3.5 | 3.5 | 3.5 | 3.5 |
| | | Primary particle size (nm) | 25 | 17 | 31 | 31 | 31 | 31 | 31 | 31 |
| | Specification of | Acid value [mgKOH/g] | 16 | 16 | 26 | 26 | 8 | 0 | 5 | 8 |
| | pigment dispersing | Amine value [mgKOH/g] | 35 | 35 | 43 | 51 | 18 | 48 | 12 | 18 |
| | resin | | | | | | | | | |
| | Content | Amount of carbon black | 2.7 | 2.7 | 2.7 | 2.7 | 2.7 | 2.7 | 2.7 | 2.7 |
| | in inkjet ink | Amount of polymerizable | 82.6 | 82.6 | 82.6 | 82.6 | 82.6 | 82.6 | 82.6 | 82.6 |
| | | compound | | | | | | | | |
| | | Amount of monofunctional | 0 | 0 | 0 | 0 | 0 | 0 | 0 | 0 |
| | | polymerizable compound | | | | | | | | |
| | | (excluding MVOZ) | | | | | | | | |
| | | Amount of bifunctional monomer | 44.6 | 44.6 | 44.6 | 44.6 | 44.6 | 44.6 | 44.6 | 44.6 |
| | | of general formula (A) | | | | | | | | |
| | | Amount of trifunctional monomer | 5 | 5 | 5 | 5 | 5 | 5 | 5 | 5 |
| | | of general formula (B) | | | | | | | | |
| | Ratio of content | Ratio of amount of bifunctional | 8.9 | 8.9 | 8.9 | 8.9 | 8.9 | 8.9 | 8.9 | 8.9 |
| | | monomer of general formula (A) | | | | | | | | |
| | | to amount of trifunctional | | | | | | | | |
| | | monomer of general formula (B) | | | | | | | | |
| | | Ratio of amount of other | 3.1 | 3.1 | 3.1 | 3.1 | 3.1 | 3.1 | 3.1 | 3.1 |
| | | polymerizable compound to | | | | | | | | |
| | | amount of MVOZ | | | | | | | | |
| | | Ratio of amount of | 0.53 | 0.53 | 0.53 | 0.53 | 0.53 | 0.53 | 0.53 | 0.53 |
| | | acylphosphine oxide compound | | | | | | | | |
| | | to amount of MVOZ | | | | | | | | |
| | | Ratio of (total) content of TPO-L | 55.6% | 55.6% | 55.6% | 55.6% | 55.6% | 55.6% | 55.6% | 55.6% |
| | | and/or TP to total amount of | | | | | | | | |
| | | photopolymerization initiator | | | | | | | | |
| | | Ratio of amount of | 3.5 | 3.5 | 3.5 | 3.5 | 3.5 | 3.5 | 3.5 | 3.5 |
| | | acylphosphine oxide compound | | | | | | | | |
| | | to amount of thioxanthone | | | | | | | | |
| | | compound | | | | | | | | |
| | | Ratio of amount of | 0.46 | 0.46 | 0.46 | 0.46 | 0.46 | 0.46 | 0.46 | 0.46 |
| | | acylphosphine oxide compound | | | | | | | | |
| | | to sum of amount of MVOZ and | | | | | | | | |
| | | amount of thioxanthone | | | | | | | | |
| | | compound | | | | | | | | |
| Evaluation | Evaluation 1 | Dispersion stability | 2 | 1 | 4 | 3 | 4 | 4 | 3 | 4 |
| results | Evaluation 2 | Discharge stability | 1 | Not | 3 | 2 | 4 | 4 | 4 | 4 |
| | | | | performed | | | | | | |
| | Evaluation 3 | Curability | 2 | 2 | 3 | 2 | 4 | 3 | 4 | 4 |
| | Evaluation 4 | Fineness of printed matter | 2 | 2 | 4 | 3 | 4 | 4 | 4 | 4 |
| | | (character visibility) | | | | | | | | |

| | | | | Example / Comparative Example | | | | | | | |
|---|---|---|---|---|---|---|---|---|---|---|---|
| | | | | | | Comparative | Comparative | | | | |
| | | | | Example 14 | Example 15 | Example 5 | Example 6 | Example 16 | Example 17 | Example 18 | Example 19 |
| Inkjet ink No. | | | | 18 | 19 | 20 | 21 | 22 | 23 | 24 | 25 |
| Content | Carbon black | Carbon black dispersion No. used | | 18 | 19 | 20 | 21 | 22 | 23 | 24 | 25 |
| | dispersion | Blending amount | | 18 | 18 | 18 | 18 | 18 | 18 | 18 | 18 |
| | Polymerizable | Radically | PDDA | | | | | | | | |
| | compound | polymerizable | BDDA | | | | | | | | |
| | | bifunctional | MPDDA | | | | | | | | |
| | | monomer | HDDA | 30 | 30 | 30 | 30 | 30 | 30 | 30 | 30 |
| | | represented by | | | | | | | | | |
| | | general formula | | | | | | | | | |
| | | (A) | | | | | | | | | |
| | | Radically | GlyTA | 5 | 5 | 5 | 5 | 5 | 5 | 5 | 5 |
| | | polymerizable | Gly(EO)3TA | | | | | | | | |
| | | trifunctional | Gly(EO)9TA | | | | | | | | |
| | | monomer | | | | | | | | | |
| | | represented by | | | | | | | | | |
| | | general formula | | | | | | | | | |
| | | (B) | | | | | | | | | |
| | | Other | CHA | | | | | | | | |
| | | monofunctional | IBXA | | | | | | | | |
| | | monomer | BzA | | | | | | | | |
| | | | VCL | | | | | | | | |
| | | Other | NDDA | | | | | | | | |
| | | bifunctional | DPGDA | 13 | 13 | 13 | 13 | 13 | 13 | 13 | 13 |
| | | monomer | PEG400DA | | | | | | | | |
| | | Other | TMP(EO)3TA | | | | | | | | |
| | | trifunctional | TMP(PO)2TA | | | | | | | | |
| | | monomer | | | | | | | | | |
| | | MVOZ | | 20 | 20 | 20 | 20 | 20 | 20 | 20 | 20 |
| | Photo- | Acylphosphine | TPO-L | 7.5 | 7.5 | 7.5 | 7.5 | 7.5 | 7.5 | 7.5 | 7.5 |
| | polymerization | oxide compound | OmnTP | | | | | | | | |
| | initiator | | Omn819 | 3 | 3 | 3 | 3 | 3 | 3 | 3 | 3 |
| | | Thioxanthone | DETX | 3 | 3 | 3 | 3 | 3 | 3 | 3 | 3 |
| | | compound | OmnTX | | | | | | | | |
| | | Alkylaminoaceto- | Omn379 | | | | | | | | |
| | | phenone compound | | | | | | | | | |
| | | Benzoaminoate | ASA | | | | | | | | |
| | | compound | | | | | | | | | |
| | Polymerization | BHT | | 0.1 | 0.1 | 0.1 | 0.1 | 0.1 | 0.1 | 0.1 | 0.1 |
| | inhibitor | | | | | | | | | | |
| | Surface additive | UV3510 | | 0.4 | 0.4 | 0.4 | 0.4 | 0.4 | 0.4 | 0.4 | 0.4 |
| Specifications | Specification of | DBP oil absorption amount (AC) | | 43 | 43 | 43 | 43 | 43 | 43 | 43 | 43 |
| | carbon black | [mL/100 g] | | | | | | | | | |
| | | Specific surface area (SC) | | 62 | 62 | 62 | 62 | 62 | 62 | 62 | 62 |
| | | [m²/g] | | | | | | | | | |
| | | AC × SC | | 2666 | 2666 | 2666 | 2666 | 2666 | 2666 | 2666 | 2666 |
| | | pH | | 3.5 | 3.5 | 3.5 | 3.5 | 3.5 | 3.5 | 3.5 | 3.5 |
| | | Primary particle size (nm) | | 31 | 31 | 31 | 31 | 31 | 31 | 31 | 31 |
| | Specification of | Acid value [mgKOH/g] | | 17 | 14 | 50 | 94 | 16 | 16 | 8 | 8 |
| | pigment dispersing | Amine value [mgKOH/g] | | 10 | 17 | 0 | 94 | 35 | 35 | 18 | 18 |
| | resin | | | | | | | | | | |
| | Content | Amount of carbon black | | 2.7 | 2.7 | 2.7 | 2.7 | 2.7 | 2.7 | 2.7 | 2.7 |
| | in inkjet ink | Amount of polymerizable | | 82.6 | 82.6 | 82.6 | 82.6 | 82.6 | 82.6 | 83.0 | 82.8 |
| | | compound | | | | | | | | | |
| | | Amount of monofunctional | | 0 | 0 | 0 | 0 | 0 | 0 | 0 | 0 |
| | | polymerizable compound | | | | | | | | | |
| | | (excluding MVOZ) | | | | | | | | | |
| | | Amount of bifunctional monomer | | 44.6 | 44.6 | 44.6 | 44.6 | 30.0 | 30.0 | 45.0 | 44.8 |
| | | of general formula (A) | | | | | | | | | |
| | | Amount of trifunctional monomer | | 5 | 5 | 5 | 5 | 5 | 5 | 5 | 5 |
| | | of general formula (B) | | | | | | | | | |
| | Ratio of content | Ratio of amount of bifunctional | | 8.9 | 8.9 | 8.9 | 8.9 | 6.0 | 6.0 | 9.0 | 9.0 |
| | | monomer of general formula (A) | | | | | | | | | |
| | | to amount of trifunctional | | | | | | | | | |
| | | monomer of general formula (B) | | | | | | | | | |
| | | Ratio of amount of other | | 3.1 | 3.1 | 3.1 | 3.1 | 3.1 | 3.1 | 3.2 | 3.1 |
| | | polymerizable compound to | | | | | | | | | |
| | | amount of MVOZ | | | | | | | | | |
| | | Ratio of amount of | | 0.53 | 0.53 | 0.53 | 0.53 | 0.53 | 0.53 | 0.53 | 0.53 |
| | | acylphosphine oxide compound | | | | | | | | | |
| | | to amount of MVOZ | | | | | | | | | |
| | | Ratio of (total) content of TPO-L | | 55.6% | 55.6% | 55.6% | 55.6% | 55.6% | 55.6% | 55.6% | 55.6% |
| | | and/or TP to total amount of | | | | | | | | | |
| | | photopolymerization initiator | | | | | | | | | |
| | | Ratio of amount of | | 3.5 | 3.5 | 3.5 | 3.5 | 3.5 | 3.5 | 3.5 | 3.5 |
| | | acylphosphine oxide compound | | | | | | | | | |
| | | to amount of thioxanthone | | | | | | | | | |
| | | compound | | | | | | | | | |
| | | Ratio of amount of | | 0.46 | 0.46 | 0.46 | 0.46 | 0.46 | 0.46 | 0.46 | 0.46 |
| | | acylphosphine oxide compound | | | | | | | | | |
| | | to sum of amount of MVOZ and | | | | | | | | | |
| | | amount of thioxanthone | | | | | | | | | |
| | | compound | | | | | | | | | |
| Evaluation | Evaluation 1 | Dispersion stability | | 3 | 4 | 1 | 1 | 4 | 4 | 3 | 4 |
| results | Evaluation 2 | Discharge stability | | 4 | 4 | Not | Not | 4 | 4 | 3 | 4 |
| | | | | | | performed | performed | | | | |
| | Evaluation 3 | Curability | | 4 | 4 | 3 | 3 | 4 | 4 | 4 | 4 |
| | Evaluation 4 | Fineness of printed matter | | 4 | 4 | 3 | 2 | 4 | 4 | 4 | 4 |
| | | (character visibility) | | | | | | | | | |
| | | | | Example / Comparative Example | | | | | | | |
| | | | | Example 20 | Example 21 | Example 22 | Example 23 | Example 24 | Example 25 | Example 26 | Example 27 |
| Inkjet ink No. | | | | 26 | 27 | 28 | 29 | 30 | 31 | 32 | 33 |
| Content | Carbon black | Carbon black dispersion No. used | | 26 | 27 | 2 | 2 | 2 | 2 | 22 | 2 |
| | dispersion | Blending amount | | 18 | 18 | 18 | 18 | 18 | 18 | 18 | 18 |
| | Polymerizable | Radically | PDDA | | | 25 | | | | | |
| | compound | polymerizable | BDDA | | | | 25 | | | | |
| | | bifunctional | MPDDA | | | | | 25 | | | |
| | | monomer | HDDA | 30 | 30 | | | | 25 | | |
| | | represented by | | | | | | | | | |
| | | general formula | | | | | | | | | |
| | | (A) | | | | | | | | | |
| | | Radically | GlyTA | 5 | 5 | | | | | | |
| | | polymerizable | Gly(EO)3TA | | | | | | | | |
| | | trifunctional | Gly(EO)9TA | | | | | | | | |
| | | monomer | | | | | | | | | |
| | | represented by | | | | | | | | | |
| | | general formula | | | | | | | | | |
| | | (B) | | | | | | | | | |
| | | Other | CHA | | | | | | | | |
| | | monofunctional | IBXA | | | | | | | | |
| | | monomer | BzA | | | | | | | | |
| | | | VCL | | | | | | | | |
| | | Other | NDDA | | | | | | | | |
| | | bifunctional | DPGDA | 13 | 13 | 5 | 5 | 5 | 5 | 30 | 30 |
| | | monomer | PEG400DA | | | 13 | 13 | 13 | 13 | 13 | 13 |
| | | Other | TMP(EO)3TA | | | | | | | | |
| | | trifunctional | TMP(PO)2TA | | | | | | | | |
| | | monomer | | | | | | | | | |
| | | MVOZ | | 20 | 20 | 25 | 25 | 25 | 25 | 25 | 25 |
| | Photo- | Acylphosphine | TPO-L | 7.5 | 7.5 | 7.5 | 7.5 | 7.5 | 7.5 | 7.5 | 7.5 |
| | polymerization | oxide compound | OmnTP | | | | | | | | |
| | initiator | | Omn819 | 3 | 3 | 3 | 3 | 3 | 3 | 3 | 3 |
| | | Thioxanthone | DETX | 3 | 3 | 3 | 3 | 3 | 3 | 3 | 3 |
| | | compound | OmnTX | | | | | | | | |
| | | Alkylaminoaceto- | Omn379 | | | | | | | | |
| | | phenone compound | | | | | | | | | |
| | | Benzoaminoate | ASA | | | | | | | | |
| | | compound | | | | | | | | | |

| | Polymerization | BHT | 0.1 | 0.1 | 0.1 | 0.1 | 0.1 | 0.1 | 0.1 | 0.1 |
|---|---|---|---|---|---|---|---|---|---|---|
| | inhibitor | | | | | | | | | |
| | Surface additive | UV3510 | 0.4 | 0.4 | 0.4 | 0.4 | 0.4 | 0.4 | 0.4 | 0.4 |
| Specifications | Specification of | DBP oil absorption amount (AC) | 43 | 43 | 43 | 43 | 43 | 43 | 43 | 43 |
| | carbon black | [mL/100 g] | | | | | | | | |
| | | Specific surface area (SC) | 62 | 62 | 62 | 62 | 62 | 62 | 62 | 62 |
| | | [m²/g] | | | | | | | | |
| | | AC × SC | 2666 | 2666 | 2666 | 2666 | 2666 | 2666 | 2666 | 2666 |
| | | pH | 3.5 | 3.5 | 3.5 | 3.5 | 3.5 | 3.5 | 3.5 | 3.5 |
| | | Primary particle size (nm) | 31 | 31 | 31 | 31 | 31 | 31 | 31 | 31 |
| | Specification of | Acid value [mgKOH/g] | 8 | 8 | 16 | 16 | 16 | 16 | 16 | 16 |
| | pigment dispersing | Amine value [mgKOH/g] | 18 | 18 | 35 | 35 | 35 | 35 | 35 | 35 |
| | resin | | | | | | | | | |
| | Content | Amount of carbon black | 2.7 | 2.7 | 2.7 | 2.7 | 2.7 | 2.7 | 2.7 | 2.7 |
| | in inkjet ink | Amount of polymerizable | 82.0 | 81.4 | 82.6 | 82.6 | 82.6 | 82.6 | 82.6 | 82.6 |
| | | compound | | | | | | | | |
| | | Amount of monofunctional | 0 | 0 | 0 | 0 | 0 | 0 | 0 | 0 |
| | | polymerizable compound | | | | | | | | |
| | | (excluding MVOZ) | | | | | | | | |
| | | Amount of bifunctional monomer | 44.0 | 43.4 | 39.6 | 39.6 | 39.6 | 39.6 | 0 | 14.6 |
| | | of general formula (A) | | | | | | | | |
| | | Amount of trifunctional monomer | 5 | 5 | 0 | 0 | 0 | 0 | 0 | 0 |
| | | of general formula (B) | | | | | | | | |
| | Ratio of content | Ratio of amount of bifunctional | 8.8 | 8.7 | (Not containing monomer of general formula (B)) | | | | (Not | (Not |
| | | monomer of general formula (A) | | | | | | | containing | containing |
| | | to amount of trifunctional | | | | | | | monomers | monomer |
| | | monomer of general formula (B) | | | | | | | of general | of general |
| | | | | | | | | | formulas | formula |
| | | | | | | | | | (A) and (B)) | (B)) |
| | | Ratio of amount of other | 3.1 | 3.1 | 2.3 | 2.3 | 2.3 | 2.3 | 2.3 | 2.3 |
| | | polymerizable compound to | | | | | | | | |
| | | amount of MVOZ | | | | | | | | |
| | | Ratio of amount of | 0.53 | 0.53 | 0.42 | 0.42 | 0.42 | 0.42 | 0.42 | 0.42 |
| | | acylphosphine oxide compound | | | | | | | | |
| | | to amount of MVOZ | | | | | | | | |
| | | Ratio of (total) content of TPO-L | 55.6% | 55.6% | 55.6% | 55.6% | 55.6% | 55.6% | 55.6% | 55.6% |
| | | and/or TP to total amount of | | | | | | | | |
| | | photopolymerization initiator | | | | | | | | |
| | | Ratio of amount of | 3.5 | 3.5 | 3.5 | 3.5 | 3.5 | 3.5 | 3.5 | 3.5 |
| | | acylphosphine oxide compound | | | | | | | | |
| | | to amount of thioxanthone | | | | | | | | |
| | | compound | | | | | | | | |
| | | Ratio of amount of | 0.46 | 0.46 | 0.38 | 0.38 | 0.38 | 0.38 | 0.38 | 0.38 |
| | | acylphosphine oxide compound | | | | | | | | |
| | | to sum of amount of MVOZ and | | | | | | | | |
| | | amount of thioxanthone | | | | | | | | |
| | | compound | | | | | | | | |
| Evaluation | Evaluation 1 | Dispersion stability | 4 | 3 | 4 | 4 | 4 | 4 | 3 | 3 |
| results | Evaluation 2 | Discharge stability | 4 | 4 | 4 | 4 | 4 | 4 | 4 | 4 |
| | Evaluation 3 | Curability | 4 | 4 | 4 | 4 | 4 | 4 | 3 | 3 |
| | Evaluation 4 | Fineness of printed matter | 4 | 4 | 4 | 4 | 4 | 4 | 3 | 3 |
| | | (character visibility) | | | | | | | | |

| | | | | Example / Comparative Example | | | | | | | |
|---|---|---|---|---|---|---|---|---|---|---|---|
| | | | | Example 28 | Example 29 | Example 30 | Example 31 | Example 32 | Example 33 | Example 34 | Example 35 |
| Inkjet ink No. | | | | 34 | 35 | 36 | 37 | 38 | 39 | 40 | 41 |
| Content | Carbon black | Carbon black dispersion No. used | | 2 | 2 | 2 | 2 | 22 | 22 | 22 | 22 |
| | dispersion | Blending amount | | 18 | 18 | 18 | 18 | 18 | 18 | 18 | 18 |
| | Polymerizable | Radically | PDDA | | | | | | | | |
| | compound | polymerizable | BDDA | | | | | | | | |
| | | bifunctional | MPDDA | | | | | | | | |
| | | monomer | HDDA | 2 | 12 | 30 | 40 | | | | |
| | | represented by | | | | | | | | | |
| | | general formula | | | | | | | | | |
| | | (A) | | | | | | | | | |
| | | Radically | GlyTA | | | | | 10 | | | |
| | | polymerizable | Gly(EO)3TA | | | | | | | | |
| | | trifunctional | Gly(EO)9TA | | | | | | | | |
| | | monomer | | | | | | | 5 | | |
| | | represented by | | | | | | | | | |
| | | general formula | | | | | | | | 5 | |
| | | (B) | | | | | | | | | |
| | | Other | CHA | | | | | | | | |
| | | monofunctional | IBXA | | | | | | | | |
| | | monomer | BzA | | | | | | | | |
| | | | VCL | | | | | | | | |
| | | Other | NDDA | | | | | | | | |
| | | bifunctional | DPGDA | 38 | 23 | | | 33 | 38 | 38 | 38 |
| | | monomer | PEG400DA | 3 | 8 | 13 | 3 | | | | |
| | | Other | TMP(EO)3TA | | | | | | | | 5 |
| | | trifunctional | TMP(PO)2TA | | | | | | | | |
| | | monomer | | | | | | | | | |
| | | MVOZ | | 25 | 25 | 25 | 25 | 25 | 25 | 25 | 25 |
| | Photo- | Acylphosphine | TPO-L | 7.5 | 7.5 | 7.5 | 7.5 | 7.5 | 7.5 | 7.5 | 7.5 |
| | polymerization | oxide compound | OmnTP | | | | | | | | |
| | initiator | | Omn819 | 3 | 3 | 3 | 3 | 3 | 3 | 3 | 3 |
| | | Thioxanthone | DETX | 3 | 3 | 3 | 3 | 3 | 3 | 3 | 3 |
| | | compound | OmnTX | | | | | | | | |
| | | Alkylaminoaceto- | Omn379 | | | | | | | | |
| | | phenone compound | | | | | | | | | |
| | | Benzoaminoate | ASA | | | | | | | | |
| | | compound | | | | | | | | | |

| | Polymerization | BHT | 0.1 | 0.1 | 0.1 | 0.1 | 0.1 | 0.1 | 0.1 | 0.1 |
|---|---|---|---|---|---|---|---|---|---|---|
| | inhibitor | | | | | | | | | |
| | Surface additive | UV3510 | 0.4 | 0.4 | 0.4 | 0.4 | 0.4 | 0.4 | 0.4 | 0.4 |
| Specifications | Specification of | DBP oil absorption amount (AC) | 43 | 43 | 43 | 43 | 43 | 43 | 43 | 43 |
| | carbon black | [mL/100 g] | | | | | | | | |
| | | Specific surface area (SC) | 62 | 62 | 62 | 62 | 62 | 62 | 62 | 62 |
| | | [m²/g] | | | | | | | | |
| | | AC × SC | 2666 | 2666 | 2666 | 2666 | 2666 | 2666 | 2666 | 2666 |
| | | pH | 3.5 | 3.5 | 3.5 | 3.5 | 3.5 | 3.5 | 3.5 | 3.5 |
| | | Primary particle size (nm) | 31 | 31 | 31 | 31 | 31 | 31 | 31 | 31 |
| | Specification of | Acid value [mgKOH/g] | 16 | 16 | 16 | 16 | 16 | 16 | 16 | 16 |
| | pigment dispersing | Amine value [mgKOH/g] | 35 | 35 | 35 | 35 | 35 | 35 | 35 | 35 |
| | resin | | | | | | | | | |
| | Content | Amount of carbon black | 2.7 | 2.7 | 2.7 | 2.7 | 2.7 | 2.7 | 2.7 | 2.7 |
| | in inkjet ink | Amount of polymerizable | 82.6 | 82.6 | 82.6 | 82.6 | 82.6 | 82.6 | 82.6 | 82.6 |
| | | compound | | | | | | | | |
| | | Amount of monofunctional | 0 | 0 | 0 | 0 | 0 | 0 | 0 | 0 |
| | | polymerizable compound | | | | | | | | |
| | | (excluding MVOZ) | | | | | | | | |
| | | Amount of bifunctional monomer | 16.6 | 26.6 | 44.6 | 54.6 | 0 | 0 | 0 | 0 |
| | | of general formula (A) | | | | | | | | |
| | | Amount of trifunctional monomer | 0 | 0 | 0 | 0 | 10 | 5 | 5 | 0 |
| | | of general formula (B) | | | | | | | | |
| | Ratio of content | Ratio of amount of bifunctional | (Not containing monomer of general formula (B)) | | | | (Not containing monomer of | | | (Not containing |
| | | monomer of general formula (A) | | | | | general formula (A)) | | | monomers of general |
| | | to amount of trifunctional | | | | | | | | formulas (A) and (B)) |
| | | monomer of general formula (B) | | | | | | | | |
| | | Ratio of amount of other | 2.3 | 2.3 | 2.3 | 2.3 | 2.3 | 2.3 | 2.3 | 2.3 |
| | | polymerizable compound to | | | | | | | | |
| | | amount of MVOZ | | | | | | | | |
| | | Ratio of amount of | 0.42 | 0.42 | 0.42 | 0.42 | 0.42 | 0.42 | 0.42 | 0.42 |
| | | acylphosphine oxide compound | | | | | | | | |
| | | to amount of MVOZ | | | | | | | | |
| | | Ratio of (total) content of TPO-L | 55.6% | 55.6% | 55.6% | 55.6% | 55.6% | 55.6% | 55.6% | 55.6% |
| | | and/or TP to total amount of | | | | | | | | |
| | | photopolymerization initiator | | | | | | | | |
| | | Ratio of amount of | 3.5 | 3.5 | 3.5 | 3.5 | 3.5 | 3.5 | 3.5 | 3.5 |
| | | acylphosphine oxide compound | | | | | | | | |
| | | to amount of thioxanthone | | | | | | | | |
| | | compound | | | | | | | | |
| | | Ratio of amount of | 0.38 | 0.38 | 0.38 | 0.38 | 0.38 | 0.38 | 0.38 | 0.38 |
| | | acylphosphine oxide compound | | | | | | | | |
| | | to sum of amount of MVOZ and | | | | | | | | |
| | | amount of thioxanthone | | | | | | | | |
| | | compound | | | | | | | | |
| Evaluation | Evaluation 1 | Dispersion stability | 3 | 4 | 4 | 4 | 4 | 4 | 4 | 4 |
| results | Evaluation 2 | Discharge stability | 4 | 4 | 4 | 4 | 4 | 4 | 4 | 3 |
| | Evaluation 3 | Curability | 3 | 4 | 4 | 3 | 4 | 4 | 4 | 3 |
| | Evaluation 4 | Fineness of printed matter | 4 | 4 | 4 | 3 | 4 | 4 | 4 | 3 |
| | | (character visibility) | | | | | | | | |

| | | | Example / Comparative Example | | | | | | | |
|---|---|---|---|---|---|---|---|---|---|---|
| | | | Example 36 | Example 37 | Example 38 | Example 39 | Example 40 | Example 41 | Example 42 | Example 43 |
| Inkjet ink No. | | | 42 | 43 | 44 | 45 | 46 | 47 | 48 | 49 |
| Content | Carbon black | Carbon black dispersion No. used | 22 | 2 | 22 | 22 | 22 | 22 | 22 | 22 |
| | dispersion | Blending amount | 18 | 18 | 18 | 18 | 18 | 18 | 18 | 18 |

| Polymerizable | Radically | PDDA | | | | | | | | |
|---|---|---|---|---|---|---|---|---|---|---|
| compound | polymerizable | BDDA | | | | | | | | |
| | bifunctional | MPDDA | | | | | | | | |
| | monomer | HDDA | | 23 | | | | | | |
| | represented by | | | | | | | | | |
| | general formula | | | | | | | | | |
| | (A) | | | | | | | | | |
| | Radically | GlyTA | | | 10 | 1 | 3 | 5 | 12 | 15 |
| | polymerizable | Gly(EO)3TA | | | | | | | | |
| | trifunctional | Gly(EO)9TA | | | | | | | | |
| | monomer | | | | | | | | | |
| | represented by | | | | | | | | | |
| | general formula | | | | | | | | | |
| | (B) | | | | | | | | | |
| | Other | CHA | | | 3 | | | | | 3 |
| | monofunctional | IBXA | | | | | | | | |
| | monomer | BzA | | | | | | | | |
| | | VCL | | | | | | | | |
| | Other | NDDA | | | | | | | | |
| | bifunctional | DPGDA | 38 | 15 | 30 | 27 | 30 | 30 | 26 | 20 |
| | monomer | PEG400DA | | | | 10 | 5 | 3 | | |
| | Other | TMP(EO)3TA | | 5 | | | | | | |
| | trifunctional | TMP(PO)2TA | 5 | | | | | | | |
| | monomer | | | | | | | | | |
| | MVOZ | | 25 | 25 | 25 | 30 | 30 | 30 | 30 | 30 |
| Photo- | Acylphosphine | TPO-L | 7.5 | 7.5 | 7.5 | 7.5 | 7.5 | 7.5 | 7.5 | 7.5 |
| polymerization | oxide compound | OmnTP | | | | | | | | |
| initiator | | Omn819 | 3 | 3 | 3 | 3 | 3 | 3 | 3 | 3 |
| | Thioxanthone | DETX | 3 | 3 | 3 | 3 | 3 | 3 | 3 | 3 |
| | compound | OmnTX | | | | | | | | |
| | Alkylaminoaceto- | Omn379 | | | | | | | | |
| | phenone compound | | | | | | | | | |
| | Benzoaminoate | ASA | | | | | | | | |
| | compound | | | | | | | | | |

| | Polymerization | BHT | 0.1 | 0.1 | 0.1 | 0.1 | 0.1 | 0.1 | 0.1 | 0.1 |
|---|---|---|---|---|---|---|---|---|---|---|
| | inhibitor | | | | | | | | | |
| | Surface additive | UV3510 | 0.4 | 0.4 | 0.4 | 0.4 | 0.4 | 0.4 | 0.4 | 0.4 |
| Specifications | Specification of | DBP oil absorption amount (AC) | 43 | 43 | 43 | 43 | 43 | 43 | 43 | 43 |
| | carbon black | [mL/100 g] | | | | | | | | |
| | | Specific surface area (SC) | 62 | 62 | 62 | 62 | 62 | 62 | 62 | 62 |
| | | [m²/g] | | | | | | | | |
| | | AC × SC | 2666 | 2666 | 2666 | 2666 | 2666 | 2666 | 2666 | 2666 |
| | | pH | 3.5 | 3.5 | 3.5 | 3.5 | 3.5 | 3.5 | 3.5 | 3.5 |
| | | Primary particle size (nm) | 31 | 31 | 31 | 31 | 31 | 31 | 31 | 31 |
| | Specification of | Acid value [mgKOH/g] | 16 | 16 | 16 | 16 | 16 | 16 | 16 | 16 |
| | pigment dispersing | Amine value [mgKOH/g] | 35 | 35 | 35 | 35 | 35 | 35 | 35 | 35 |
| | resin | | | | | | | | | |
| | Content | Amount of carbon black | 2.7 | 2.7 | 2.7 | 2.7 | 2.7 | 2.7 | 2.7 | 2.7 |
| | in inkjet ink | Amount of polymerizable | 82.6 | 82.6 | 82.6 | 82.6 | 82.6 | 82.6 | 82.6 | 82.6 |
| | | compound | | | | | | | | |
| | | Amount of monofunctional | 0 | 0 | 3 | 0 | 0 | 0 | 0 | 3 |
| | | polymerizable compound | | | | | | | | |
| | | (excluding MVOZ) | | | | | | | | |
| | | Amount of bifunctional monomer | 0 | 37.6 | 0 | 0 | 0 | 0 | 0 | 0 |
| | | of general formula (A) | | | | | | | | |
| | | Amount of trifunctional monomer | 0 | 0 | 10 | 1 | 3 | 5 | 12 | 15 |
| | | of general formula (B) | | | | | | | | |
| | Ratio of content | Ratio of amount of bifunctional | (Not | (Not | (Not containing monomer of general formula (A) | | | | | |
| | | monomer of general formula (A) | containing | containing | | | | | | |
| | | to amount of trifunctional | monomers | monomer | | | | | | |
| | | monomer of general formula (B) | of general | of general | | | | | | |
| | | | formulas | formula | | | | | | |
| | | | (A) and (B)) | (B) | | | | | | |
| | | Ratio of amount of other | 2.3 | 2.3 | 2.3 | 1.8 | 1.8 | 1.8 | 1.8 | 1.8 |
| | | polymerizable compound to | | | | | | | | |
| | | amount of MVOZ | | | | | | | | |
| | | Ratio of amount of | 0.42 | 0.42 | 0.42 | 0.35 | 0.35 | 0.35 | 0.35 | 0.35 |
| | | acylphosphine oxide compound | | | | | | | | |
| | | to amount of MVOZ | | | | | | | | |
| | | Ratio of (total) content of TPO-L | 55.6% | 55.6% | 55.6% | 55.6% | 55.6% | 55.6% | 55.6% | 55.6% |
| | | and/or TP to total amount of | | | | | | | | |
| | | photopolymerization initiator | | | | | | | | |
| | | Ratio of amount of | 3.5 | 3.5 | 3.5 | 3.5 | 3.5 | 3.5 | 3.5 | 3.5 |
| | | acylphosphine oxide compound | | | | | | | | |
| | | to amount of thioxanthone | | | | | | | | |
| | | compound | | | | | | | | |
| | | Ratio of amount of | 0.38 | 0.38 | 0.38 | 0.32 | 0.32 | 0.32 | 0.32 | 0.32 |
| | | acylphosphine oxide compound | | | | | | | | |
| | | to sum of amount of MVOZ and | | | | | | | | |
| | | amount of thioxanthone | | | | | | | | |
| | | compound | | | | | | | | |
| Evaluation | Evaluation 1 | Dispersion stability | 4 | 4 | 4 | 4 | 4 | 4 | 4 | 4 |
| results | Evaluation 2 | Discharge stability | 3 | 3 | 4 | 3 | 4 | 4 | 4 | 3 |
| | Evaluation 3 | Curability | 3 | 4 | 4 | 3 | 3 | 4 | 4 | 4 |
| | Evaluation 4 | Fineness of printed matter | 3 | 4 | 4 | 3 | 4 | 4 | 4 | 4 |
| | | (character visibility) | | | | | | | | |

| | | | | Example / Comparative Example | | | | | | | |
|---|---|---|---|---|---|---|---|---|---|---|---|
| | | | | Example 44 | Example 45 | Example 46 | Example 47 | Example 48 | Example 49 | Example 50 | Example 51 |
| Inkjet ink No. | | | | 50 | 51 | 52 | 53 | 54 | 55 | 56 | 57 |
| Content | Carbon black | Carbon black dispersion No. used | | 22 | 2 | 23 | 2 | 2 | 2 | 2 | 2 |
| | dispersion | Blending amount | | 18 | 18 | 18 | 18 | 18 | 18 | 18 | 18 |
| | Polymerizable | Radically | PDDA | | | | | | | | |
| | compound | polymerizable | BDDA | | 15 | | | 20 | | | |
| | | bifunctional | MPDDA | | | | 10 | | | | |
| | | monomer | HDDA | 25 | 15 | 25 | 20 | 10 | 20 | 20 | 20 |
| | | represented by | | | | | | | | | |
| | | general formula | | | | | | | | | |
| | | (A) | | | | | | | | | |
| | | Radically | GlyTA | 10 | | 5 | 5 | | | | |
| | | polymerizable | Gly(EO)3TA | | 3 | | | 5 | | | |
| | | trifunctional | Gly(EO)9TA | | | | | | | | |
| | | monomer | | | | | | | | | |
| | | represented by | | | | | | | | | |
| | | general formula | | | | | | | | | |
| | | (B) | | | | | | | | | |
| | | Other | CHA | | | | 3 | | 10 | | |
| | | monofunctional | IBXA | 3 | | | | 3 | | | 10 |
| | | monomer | BzA | | | | | | | 10 | |
| | | | VCL | | | | | | | | |
| | | Other | NDDA | | | 5 | | | | | |
| | | bifunctional | DPGDA | 5 | 8 | 13 | 10 | 10 | | | |
| | | monomer | PEG400DA | | | | | | 13 | 13 | 13 |
| | | Other | TMP(EO)3TA | | | | | 5 | | | |
| | | trifunctional | TMP(PO)2TA | | 2 | | | | | | |
| | | monomer | | | | | | | | | |
| | | MVOZ | | 25 | 25 | 20 | 20 | 15 | 25 | 25 | 25 |
| | Photo- | Acylphosphine | TPO-L | 7.5 | 7.5 | 7.5 | 7.5 | 7.5 | 7.5 | 7.5 | 7.5 |
| | polymerization | oxide compound | OmnTP | | | | | | | | |
| | initiator | | Omn819 | 3 | 3 | 3 | 3 | 3 | 3 | 3 | 3 |
| | | Thioxanthone | DETX | 3 | 3 | 3 | 3 | 3 | 3 | 3 | 3 |
| | | compound | OmnTX | | | | | | | | |
| | | Alkylaminoaceto- | Omn379 | | | | | | | | |
| | | phenone compound | | | | | | | | | |
| | | Benzoaminoate | ASA | | | | | | | | |
| | | compound | | | | | | | | | |

| | Polymerization | BHT | 0.1 | 0.1 | 0.1 | 0.1 | 0.1 | 0.1 | 0.1 | 0.1 |
|---|---|---|---|---|---|---|---|---|---|---|
| | inhibitor | | | | | | | | | |
| | Surface additive | UV3510 | 0.4 | 0.4 | 0.4 | 0.4 | 0.4 | 0.4 | 0.4 | 0.4 |
| Specifications | Specification of | DBP oil absorption amount (AC) | 43 | 43 | 43 | 43 | 43 | 43 | 43 | 43 |
| | carbon black | [mL/100 g] | | | | | | | | |
| | | Specific surface area (SC) | 62 | 62 | 62 | 62 | 62 | 62 | 62 | 62 |
| | | [m²/g] | | | | | | | | |
| | | AC × SC | 2666 | 2666 | 2666 | 2666 | 2666 | 2666 | 2666 | 2666 |
| | | pH | 3.5 | 3.5 | 3.5 | 3.5 | 3.5 | 3.5 | 3.5 | 3.5 |
| | | Primary particle size (nm) | 31 | 31 | 31 | 31 | 31 | 31 | 31 | 31 |
| | Specification of | Acid value [mgKOH/g] | 16 | 16 | 16 | 16 | 16 | 16 | 16 | 16 |
| | pigment dispersing | Amine value [mgKOH/g] | 35 | 35 | 35 | 35 | 35 | 35 | 35 | 35 |
| | resin | | | | | | | | | |
| | Content | Amount of carbon black | 2.7 | 2.7 | 2.7 | 2.7 | 2.7 | 2.7 | 2.7 | 2.7 |
| | in inkjet ink | Amount of polymerizable | 82.6 | 82.6 | 82.6 | 82.6 | 82.6 | 82.6 | 82.6 | 82.6 |
| | | compound | | | | | | | | |
| | | Amount of monofunctional | 3 | 0 | 0 | 3 | 3 | 10 | 10 | 10 |
| | | polymerizable compound | | | | | | | | |
| | | (excluding MVOZ) | | | | | | | | |
| | | Amount of bifunctional monomer | 25.0 | 44.6 | 25.0 | 44.6 | 44.6 | 34.6 | 34.6 | 34.6 |
| | | of general formula (A) | | | | | | | | |
| | | Amount of trifunctional monomer | 10 | 3 | 5 | 5 | 5 | 0 | 0 | 0 |
| | | of general formula (B) | | | | | | | | |
| | Ratio of content | Ratio of amount of bifunctional | 2.5 | 14.9 | 5.0 | 8.9 | 8.9 | (Not containing monomer of general formula (B)) | | |
| | | monomer of general formula (A) | | | | | | | | |
| | | to amount of trifunctional | | | | | | | | |
| | | monomer of general formula (B) | | | | | | | | |
| | | Ratio of amount of other | 2.3 | 2.3 | 3.1 | 3.1 | 4.5 | 2.3 | 2.3 | 2.3 |
| | | polymerizable compound to | | | | | | | | |
| | | amount of MVOZ | | | | | | | | |
| | | Ratio of amount of | 0.42 | 0.42 | 0.53 | 0.53 | 0.70 | 0.42 | 0.42 | 0.42 |
| | | acylphosphine oxide compound | | | | | | | | |
| | | to amount of MVOZ | | | | | | | | |
| | | Ratio of (total) content of TPO-L | 55.6% | 55.6% | 55.6% | 55.6% | 55.6% | 55.6% | 55.6% | 55.6% |
| | | and/or TP to total amount of | | | | | | | | |
| | | photopolymerization initiator | | | | | | | | |
| | | Ratio of amount of | 3.5 | 3.5 | 3.5 | 3.5 | 3.5 | 3.5 | 3.5 | 3.5 |
| | | acylphosphine oxide compound | | | | | | | | |
| | | to amount of thioxanthone | | | | | | | | |
| | | compound | | | | | | | | |
| | | Ratio of amount of | 0.38 | 0.38 | 0.46 | 0.46 | 0.58 | 0.38 | 0.38 | 0.38 |
| | | acylphosphine oxide compound | | | | | | | | |
| | | to sum of amount of MVOZ and | | | | | | | | |
| | | amount of thioxanthone | | | | | | | | |
| | | compound | | | | | | | | |
| Evaluation | Evaluation 1 | Dispersion stability | 4 | 4 | 4 | 4 | 4 | 4 | 3 | 4 |
| results | Evaluation 2 | Discharge stability | 4 | 4 | 4 | 4 | 4 | 4 | 4 | 4 |
| | Evaluation 3 | Curability | 4 | 4 | 4 | 4 | 4 | 3 | 2 | 3 |
| | Evaluation 4 | Fineness of printed matter | 4 | 4 | 4 | 4 | 4 | 3 | 2 | 3 |
| | | (character visibility) | | | | | | | | |

| | | | | Example / Comparative Example | | | | | | | |
|---|---|---|---|---|---|---|---|---|---|---|---|
| | | | | Comparative | | | | Comparative | Comparative | | |
| | | | | Example 7 | Example 52 | Example 53 | Example 54 | Example 8 | Example 9 | Example 55 | Example 56 |
| Inkjet ink No. | | | | 58 | 59 | 60 | 61 | 62 | 63 | 64 | 65 |
| Content | Carbon black | Carbon black dispersion No. used | | 2 | 2 | 2 | 2 | 2 | 2 | 2 | 2 |
| | dispersion | Blending amount | | 18 | 18 | 18 | 18 | 18 | 18 | 18 | 18 |
| | Polymerizable | Radically | PDDA | | | | | | | | |
| | compound | polymerizable | BDDA | | | | | | | | |
| | | bifunctional | MPDDA | | | | | | | | |
| | | monomer | HDDA | 12 | 15 | 24 | 27 | 30 | 30 | 30 | 30 |
| | | represented by | | | | | | | | | |
| | | general formula | | | | | | | | | |
| | | (A) | | | | | | | | | |
| | | Radically | GlyTA | | | | | 5 | | | |
| | | polymerizable | Gly(EO)3TA | | | | | | | | |
| | | trifunctional | Gly(EO)9TA | | | | | | | | |
| | | monomer | | | | | | | | | |
| | | represented by | | | | | | | | | |
| | | general formula | | | | | | | | | |
| | | (B) | | | | | | | | | |
| | | Other | CHA | | | | | | | | |
| | | monofunctional | IBXA | 18 | 15 | 6 | 3 | | | | |
| | | monomer | BzA | | | | | | | | |
| | | | VCL | | | | | 20 | | | |
| | | Other | NDDA | | | | | | | | |
| | | bifunctional | DPGDA | | | | | 13 | 35 | 30 | 27.5 |
| | | monomer | PEG400DA | 13 | 13 | 13 | 13 | | 3 | 3 | 3 |
| | | Other | TMP(EO)3TA | | | | | | | | |
| | | trifunctional | TMP(PO)2TA | | | | | | | | |
| | | monomer | | | | | | | | | |
| | | MVOZ | | 25 | 25 | 25 | 25 | | | 5 | 6 |
| | Photo- | Acylphosphine | TPO-L | 7.5 | 7.5 | 7.5 | 7.5 | 7.5 | 7.5 | 7.5 | 7.5 |
| | polymerization | oxide compound | OmnTP | | | | | | | | |
| | initiator | | Omn819 | 3 | 3 | 3 | 3 | 3 | 3 | 3 | 3 |
| | | Thioxanthone | DETX | 3 | 3 | 3 | 3 | 3 | 3 | 3 | 4.5 |
| | | compound | OmnTX | | | | | | | | |
| | | Alkylaminoaceto- | Omn379 | | | | | | | | |
| | | phenone compound | | | | | | | | | |
| | | Benzoaminoate | ASA | | | | | | | | |
| | | compound | | | | | | | | | |
| | Polymerization | BHT | | 0.1 | 0.1 | 0.1 | 0.1 | 0.1 | 0.1 | 0.1 | 0.1 |
| | inhibitor | | | | | | | | | | |
| | Surface additive | UV3510 | | 0.4 | 0.4 | 0.4 | 0.4 | 0.4 | 0.4 | 0.4 | 0.4 |
| Specifications | Specification of | DBP oil absorption amount (AC) | | 43 | 43 | 43 | 43 | 43 | 43 | 43 | 43 |
| | carbon black | [mL/100 g] | | | | | | | | | |
| | | Specific surface area (SC) | | 62 | 62 | 62 | 62 | 62 | 62 | 62 | 62 |
| | | [m²/g] | | | | | | | | | |
| | | AC × SC | | 2666 | 2666 | 2666 | 2666 | 2666 | 2666 | 2666 | 2666 |
| | | pH | | 3.5 | 3.5 | 3.5 | 3.5 | 3.5 | 3.5 | 3.5 | 3.5 |
| | | Primary particle size (nm) | | 31 | 31 | 31 | 31 | 31 | 31 | 31 | 31 |
| | Specification of | Acid value [mgKOH/g] | | 16 | 16 | 16 | 16 | 16 | 16 | 16 | 16 |
| | pigment dispersing | Amine value [mgKOH/g] | | 35 | 35 | 35 | 35 | 35 | 35 | 35 | 35 |
| | resin | | | | | | | | | | |
| | Content | Amount of carbon black | | 2.7 | 2.7 | 2.7 | 2.7 | 2.7 | 2.7 | 2.7 | 2.7 |
| | in inkjet ink | Amount of polymerizable | | 82.6 | 82.6 | 82.6 | 82.6 | 82.6 | 82.6 | 82.6 | 81.1 |
| | | compound | | | | | | | | | |
| | | Amount of monofunctional | | 18 | 15 | 6 | 3 | 20 | 0 | 0 | 0 |
| | | polymerizable compound | | | | | | | | | |
| | | (excluding MVOZ) | | | | | | | | | |
| | | Amount of bifunctional monomer | | 26.6 | 29.6 | 38.6 | 41.6 | 44.6 | 44.6 | 44.6 | 44.6 |
| | | of general formula (A) | | | | | | | | | |
| | | Amount of trifunctional monomer | | 0 | 0 | 0 | 0 | 5 | 0 | 0 | 0 |
| | | of general formula (B) | | | | | | | | | |
| | Ratio of content | Ratio of amount of bifunctional | | (Not containing monomer of general formula (B)) | | | | 8.9 | (Not containing monomer of | | |
| | | monomer of general formula (A) | | | | | | | general formula (B)) | | |
| | | to amount of trifunctional | | | | | | | | | |
| | | monomer of general formula (B) | | | | | | | | | |
| | | Ratio of amount of other | | 2.3 | 2.3 | 2.3 | 2.3 | | | 15.5 | 12.5 |
| | | polymerizable compound to | | | | | | | | | |
| | | amount of MVOZ | | | | | | | | | |
| | | Ratio of amount of | | 0.42 | 0.42 | 0.42 | 0.42 | (Not containing MVOZ) | | 2.10 | 1.75 |
| | | acylphosphine oxide compound | | | | | | | | | |
| | | to amount of MVOZ | | | | | | | | | |
| | | Ratio of (total) content of TPO-L | | 55.6% | 55.6% | 55.6% | 55.6% | 55.6% | 55.6% | 55.6% | 50.0% |
| | | and/or TP to total amount of | | | | | | | | | |
| | | photopolymerization initiator | | | | | | | | | |
| | | Ratio of amount of | | 3.5 | 3.5 | 3.5 | 3.5 | 3.5 | 3.5 | 3.5 | 2.3 |
| | | acylphosphine oxide compound | | | | | | | | | |
| | | to amount of thioxanthone | | | | | | | | | |
| | | compound | | | | | | | | | |
| | | Ratio of amount of | | 0.38 | 0.38 | 0.38 | 0.38 | (Not containing MVOZ) | | 1.31 | 1.00 |
| | | acylphosphine oxide compound | | | | | | | | | |
| | | to sum of amount of MVOZ and | | | | | | | | | |
| | | amount of thioxanthone | | | | | | | | | |
| | | compound | | | | | | | | | |
| Evaluation | Evaluation 1 | Dispersion stability | | 4 | 4 | 4 | 4 | 1 | 4 | 4 | 4 |
| results | Evaluation 2 | Discharge stability | | 3 | 3 | 4 | 4 | Not | 3 | 2 | 3 |
| | | | | | | | | performed | | | |
| | Evaluation 3 | Curability | | 1 | 2 | 4 | 4 | 2 | 1 | 2 | 2 |
| | Evaluation 4 | Fineness of printed matter | | 2 | 2 | 3 | 4 | 2 | 1 | 2 | 3 |
| | | (character visibility) | | | | | | | | | |
| | | | | Example / Comparative Example | | | | | | | |
| | | | | Example 57 | Example 58 | Example 59 | Example 60 | Example 61 | Example 62 | Example 63 | Example 64 |
| Inkjet ink No. | | | | 66 | 67 | 68 | 69 | 70 | 71 | 72 | 73 |
| Content | Carbon black | Carbon black dispersion No. used | | 2 | 2 | 2 | 2 | 2 | 2 | 2 | 2 |
| | dispersion | Blending amount | | 18 | 18 | 18 | 18 | 18 | 18 | 18 | 18 |
| | Polymerizable | Radically | PDDA | | | | | | | | |
| | compound | polymerizable | BDDA | | | | | | | | |
| | | bifunctional | MPDDA | | | | | | | | |
| | | monomer | HDDA | 30 | 30 | 25 | 21 | 16.5 | 25 | 25 | 25 |
| | | represented by | | | | | | | | | |
| | | general formula | | | | | | | | | |
| | | (A) | | | | | | | | | |
| | | Radically | GlyTA | | | | | | | | |
| | | polymerizable | Gly(EO)3TA | | | | | | | | |
| | | trifunctional | Gly(EO)9TA | | | | | | | | |
| | | monomer | | | | | | | | | |
| | | represented by | | | | | | | | | |
| | | general formula | | | | | | | | | |
| | | (B) | | | | | | | | | |
| | | Other | CHA | | | | | | | | |
| | | monofunctional | IBXA | | | | | | | | |
| | | monomer | BzA | | | | | | | | |
| | | | VCL | | | | | | | | |
| | | Other | NDDA | | | | | | | | |
| | | bifunctional | DPGDA | 23 | 15 | | | | 10 | 8 | 8 |
| | | monomer | PEG400DA | 5 | 8 | 13 | 13 | 13 | 10 | 10 | 8 |
| | | Other | TMP(EO)3TA | | | | | | | | |
| | | trifunctional | TMP(PO)2TA | | | | | | | | |
| | | monomer | | | | | | | | | |
| | | MVOZ | | 10 | 15 | 30 | 35 | 40 | 25 | 25 | 25 |
| | Photo- | Acylphosphine | TPO-L | 7.5 | 7.5 | 7.5 | 7 | 6.5 | | 7.5 | 8 |
| | polymerization | oxide compound | OmnTP | | | | | | 6 | | |
| | initiator | | Omn819 | 3 | 3 | 3 | 2.5 | 2.5 | 2.5 | 3 | 2.5 |
| | | Thioxanthone | DETX | 3 | 3 | 3 | 3 | 3 | 3 | | |
| | | compound | OmnTX | | | | | | | 3 | |
| | | Alkylaminoaceto- | Omn379 | | | | | | | | 5 |
| | | phenone compound | | | | | | | | | |
| | | Benzoaminoate | ASA | | | | | | | | |
| | | compound | | | | | | | | | |
| | Polymerization | BHT | | 0.1 | 0.1 | 0.1 | 0.1 | 0.1 | 0.1 | 0.1 | 0.1 |
| | inhibitor | | | | | | | | | | |
| | Surface additive | UV3510 | | 0.4 | 0.4 | 0.4 | 0.4 | 0.4 | 0.4 | 0.4 | 0.4 |
| Specifications | Specification of | DBP oil absorption amount (AC) | | 43 | 43 | 43 | 43 | 43 | 43 | 43 | 43 |
| | carbon black | [mL/100 g] | | | | | | | | | |
| | | Specific surface area (SC) | | 62 | 62 | 62 | 62 | 62 | 62 | 62 | 62 |
| | | [m²/g] | | | | | | | | | |
| | | AC × SC | | 2666 | 2666 | 2666 | 2666 | 2666 | 2666 | 2666 | 2666 |
| | | pH | | 3.5 | 3.5 | 3.5 | 3.5 | 3.5 | 3.5 | 3.5 | 3.5 |
| | | Primary particle size (nm) | | 31 | 31 | 31 | 31 | 31 | 31 | 31 | 31 |
| | Specification of | Acid value [mgKOH/g] | | 16 | 16 | 16 | 16 | 16 | 16 | 16 | 16 |
| | pigment dispersing | Amine value [mgKOH/g] | | 35 | 35 | 35 | 35 | 35 | 35 | 35 | 35 |
| | resin | | | | | | | | | | |
| | Content | Amount of carbon black | | 2.7 | 2.7 | 2.7 | 2.7 | 2.7 | 2.7 | 2.7 | 2.7 |
| | in inkjet ink | Amount of polymerizable | | 82.6 | 82.6 | 82.6 | 83.6 | 84.1 | 84.6 | 82.6 | 80.6 |
| | | compound | | | | | | | | | |
| | | Amount of monofunctional | | 0 | 0 | 0 | 0 | 0 | 0 | 0 | 0 |
| | | polymerizable compound | | | | | | | | | |
| | | (excluding MVOZ) | | | | | | | | | |
| | | Amount of bifunctional monomer | | 44.6 | 44.6 | 39.6 | 35.6 | 31.1 | 39.6 | 39.6 | 39.6 |
| | | of general formula (A) | | | | | | | | | |
| | | Amount of trifunctional monomer | | 0 | 0 | 0 | 0 | 0 | 0 | 0 | 0 |
| | | of general formula (B) | | | | | | | | | |
| | Ratio of content | Ratio of amount of bifunctional | | (Not containing monomer of general formula (B)) | | | | | | | |
| | | monomer of general formula (A) | | | | | | | | | |
| | | to amount of trifunctional | | | | | | | | | |
| | | monomer of general formula (B) | | | | | | | | | |
| | | Ratio of amount of other | | 7.3 | 4.5 | 1.8 | 1.4 | 1.1 | 2.4 | 2.3 | 2.2 |
| | | polymerizable compound to | | | | | | | | | |
| | | amount of MVOZ | | | | | | | | | |
| | | Ratio of amount of | | 1.05 | 0.70 | 0.35 | 0.27 | 0.23 | 0.34 | 0.42 | 0.42 |
| | | acylphosphine oxide compound | | | | | | | | | |
| | | to amount of MVOZ | | | | | | | | | |
| | | Ratio of (total) content of TPO-L | | 55.6% | 55.6% | 55.6% | 56.0% | 54.2% | 52.2% | 55.6% | 51.6% |
| | | and/or TP to total amount of | | | | | | | | | |
| | | photopolymerization initiator | | | | | | | | | |
| | | Ratio of amount of | | 3.5 | 3.5 | 3.5 | 3.2 | 3.0 | 2.8 | 3.5 | (Not |
| | | acylphosphine oxide compound | | | | | | | | | containing |
| | | to amount of thioxanthone | | | | | | | | | thioxanthone |
| | | compound | | | | | | | | | compound) |
| | | Ratio of amount of | | 0.81 | 0.58 | 0.32 | 0.25 | 0.21 | 0.30 | 0.38 | |
| | | acylphosphine oxide compound | | | | | | | | | |
| | | to sum of amount of MVOZ and | | | | | | | | | |
| | | amount of thioxanthone | | | | | | | | | |
| | | compound | | | | | | | | | |
| Evaluation | Evaluation 1 | Dispersion stability | | 4 | 4 | 4 | 3 | 2 | 4 | 4 | 3 |
| results | Evaluation 2 | Discharge stability | | 4 | 4 | 4 | 3 | 3 | 4 | 4 | 3 |
| | Evaluation 3 | Curability | | 3 | 4 | 4 | 4 | 4 | 4 | 4 | 2 |
| | Evaluation 4 | Fineness of printed matter | | 3 | 4 | 4 | 4 | 3 | 4 | 4 | 2 |
| | | (character visibility) | | | | | | | | | |
| | | | | Example / Comparative Example | | | | | | | |
| | | | | Example 65 | Example 66 | Example 67 | Example 68 | Example 69 | Example 70 | Example 71 | Example 72 |
| Inkjet ink No. | | | | 74 | 75 | 76 | 77 | 78 | 79 | 80 | 81 |
| Content | Carbon black | Carbon black dispersion No. used | | 2 | 2 | 2 | 2 | 2 | 2 | 2 | 2 |
| | dispersion | Blending amount | | 18 | 18 | 18 | 18 | 18 | 18 | 18 | 18 |
| | Polymerizable | Radically | PDDA | | | | | | | | |
| | compound | polymerizable | BDDA | | | | | | | | |
| | | bifunctional | MPDDA | | | | | | | | |
| | | monomer | HDDA | 25 | 25 | 25 | 25 | 25 | 25 | 25 | 25 |
| | | represented by | | | | | | | | | |
| | | general formula | | | | | | | | | |
| | | (A) | | | | | | | | | |
| | | Radically | GlyTA | | | | | | | | |
| | | polymerizable | Gly(EO)3TA | | | | | | | | |
| | | trifunctional | Gly(EO)9TA | | | | | | | | |
| | | monomer | | | | | | | | | |
| | | represented by | | | | | | | | | |
| | | general formula | | | | | | | | | |
| | | (B) | | | | | | | | | |
| | | Other | CHA | | | | | | | | |
| | | monofunctional | IBXA | | | | | | | | |
| | | monomer | BzA | | | | | | | | |
| | | | VCL | | | | | | | | |
| | | Other | NDDA | | | | | | | | |
| | | bifunctional | DPGDA | 8 | 5.5 | 7.5 | 7.5 | 8 | 7.5 | 7.5 | 7.5 |
| | | monomer | PEG400DA | 8 | 13 | 13 | 18 | 16 | 15 | 15 | 15 |
| | | Other | TMP(EO)3TA | | | | | | | | |
| | | trifunctional | TMP(PO)2TA | | | | | | | | |
| | | monomer | | | | | | | | | |
| | | MVOZ | | 25 | 25 | 30 | 25 | 25 | 25 | 25 | 25 |
| | Photo- | Acylphosphine | TPO-L | 9 | 7 | 2 | 2 | 3 | 3.5 | 4.2 | 4.5 |
| | polymerization | oxide compound | OmnTP | | | | | | | | |
| | initiator | | Omn819 | 3.5 | 2 | 1 | 1 | 1.5 | 2.5 | 1.8 | 1.5 |
| | | Thioxanthone | DETX | | 2 | 3 | 3 | 3 | 3 | 3 | 3 |
| | | compound | OmnTX | | | | | | | | |
| | | Alkylaminoaceto- | Omn379 | | | | | | | | |
| | | phenone compound | | | | | | | | | |
| | | Benzoaminoate | ASA | 3 | 2 | | | | | | |
| | | compound | | | | | | | | | |
| | Polymerization | BHT | | 0.1 | 0.1 | 0.1 | 0.1 | 0.1 | 0.1 | 0.1 | 0.1 |
| | inhibitor | | | | | | | | | | |
| | Surface additive | UV3510 | | 0.4 | 0.4 | 0.4 | 0.4 | 0.4 | 0.4 | 0.4 | 0.4 |
| Specifications | Specification of | DBP oil absorption amount (AC) | | 43 | 43 | 43 | 43 | 43 | 43 | 43 | 43 |
| | | [mL/100 g] | | | | | | | | | |
| | carbon black | Specific surface area (SC) | | 62 | 62 | 62 | 62 | 62 | 62 | 62 | 62 |
| | | [m²/g] | | | | | | | | | |
| | | AC × SC | | 2666 | 2666 | 2666 | 2666 | 2666 | 2666 | 2666 | 2666 |
| | | pH | | 3.5 | 3.5 | 3.5 | 3.5 | 3.5 | 3.5 | 3.5 | 3.5 |
| | | Primary particle size (nm) | | 31 | 31 | 31 | 31 | 31 | 31 | 31 | 31 |
| | Specification of | Acid value [mgKOH/g] | | 16 | 16 | 16 | 16 | 16 | 16 | 16 | 16 |
| | pigment dispersing | | | | | | | | | | |
| | resin | Amine value [mgKOH/g] | | 35 | 35 | 35 | 35 | 35 | 35 | 35 | 35 |
| | Content | Amount of carbon black | | 2.7 | 2.7 | 2.7 | 2.7 | 2.7 | 2.7 | 2.7 | 2.7 |
| | in inkjet ink | Amount of polymerizable | | 80.6 | 83.1 | 90.1 | 90.1 | 88.6 | 87.1 | 87.1 | 87.1 |
| | | compound | | | | | | | | | |
| | | Amount of monofunctional | | 0 | 0 | 0 | 0 | 0 | 0 | 0 | 0 |
| | | polymerizable compound | | | | | | | | | |
| | | (excluding MVOZ) | | | | | | | | | |
| | | Amount of bifunctional monomer | | 39.6 | 39.6 | 39.6 | 39.6 | 39.6 | 39.6 | 39.6 | 39.6 |
| | | of general formula (A) | | | | | | | | | |
| | | Amount of trifunctional monomer | | 0 | 0 | 0 | 0 | 0 | 0 | 0 | 0 |
| | | of general formula (B) | | | | | | | | | |
| | Ratio of content | Ratio of amount of bifunctional | | (Not containing monomer of general formula (B)) | | | | | | | |
| | | monomer of general formula (A) | | | | | | | | | |
| | | to amount of trifunctional | | | | | | | | | |
| | | monomer of general formula (B) | | | | | | | | | |
| | | Ratio of amount of other | | 2.2 | 2.3 | 2.0 | 2.6 | 2.5 | 2.5 | 2.5 | 2.5 |
| | | polymerizable compound to | | | | | | | | | |
| | | amount of MVOZ | | | | | | | | | |
| | | Ratio of amount of | | 0.50 | 0.32 | 0.10 | 0.12 | 0.18 | 0.24 | 0.24 | 0.24 |
| | | acylphosphine oxide compound | | | | | | | | | |
| | | to amount of MVOZ | | | | | | | | | |
| | | Ratio of (total) content of TPO-L | | 58.1% | 53.8% | 33.3% | 33.3% | 40.0% | 38.9% | 46.7% | 50.0% |
| | | and/or TP to total amount of | | | | | | | | | |
| | | photopolymerization initiator | | | | | | | | | |
| | | Ratio of amount of | | (Not | 2.7 | 1.0 | 1.0 | 1.5 | 2.0 | 2.0 | 2.0 |
| | | acylphosphine oxide compound | | containing | | | | | | | |
| | | to amount of thioxanthone | | thioxanthone | | | | | | | |
| | | compound | | compound) | | | | | | | |
| | | Ratio of amount of | | | 0.29 | 0.09 | 0.11 | 0.16 | 0.21 | 0.21 | 0.21 |
| | | acylphosphine oxide compound | | | | | | | | | |
| | | to sum of amount of MVOZ and | | | | | | | | | |
| | | amount of thioxanthone | | | | | | | | | |
| | | compound | | | | | | | | | |
| Evaluation | Evaluation 1 | Dispersion stability | | 3 | 4 | 4 | 4 | 4 | 4 | 4 | 4 |
| results | Evaluation 2 | Discharge stability | | 2 | 4 | 2 | 4 | 4 | 3 | 4 | 4 |
| | Evaluation 3 | Curability | | 3 | 4 | 2 | 2 | 2 | 3 | 3 | 4 |
| | Evaluation 4 | Fineness of printed matter | | 3 | 4 | 2 | 2 | 3 | 3 | 4 | 4 |
| | | (character visibility) | | | | | | | | | |
| | | | | Example / Comparative Example | | | | | | | |
| | | | | Example 73 | Example 74 | Example 75 | Example 76 | Example 77 | Example 78 | Example 79 | Example 80 |
| Inkjet ink No. | | | | 82 | 83 | 84 | 85 | 86 | 87 | 88 | 89 |
| Content | Carbon black | Carbon black dispersion No. used | | 2 | 2 | 2 | 2 | 2 | 2 | 2 | 2 |
| | dispersion | Blending amount | | 18 | 18 | 18 | 18 | 18 | 18 | 18 | 18 |
| | Polymerizable | Radically | PDDA | | | | | | | | |
| | compound | polymerizable | BDDA | | | | | | | | |
| | | bifunctional | MPDDA | | | | | | | | |
| | | monomer | HDDA | 25 | 25 | 25 | 25 | 25 | 25 | 25 | 25 |
| | | represented by | | | | | | | | | |
| | | general formula | | | | | | | | | |
| | | (A) | | | | | | | | | |
| | | Radically | Gly TA | | | | | | | | |
| | | polymerizable | Gly(EO)3TA | | | | | | | | |
| | | trifunctional | Gly(EO)9TA | | | | | | | | |
| | | monomer | | | | | | | | | |
| | | represented by | | | | | | | | | |
| | | general formula | | | | | | | | | |
| | | (B) | | | | | | | | | |
| | | Other | CHA | | | | | | | | |
| | | monofunctional | IBXA | | | | | | | | |
| | | monomer | BzA | | | | | | | | |
| | | | VCL | | | | | | | | |
| | | Other | NDDA | | | | | | | | |
| | | bifunctional | DPGDA | 10.5 | 10.5 | 10.5 | 11.5 | 7 | 7 | 10 | 10 |
| | | monomer | PEG400DA | 6 | 6 | 6 | 2 | 13 | 13 | 6 | 3.5 |
| | | Other | TMP(EO)3TA | | | | | | | | |
| | | trifunctional | TMP(PO)2TA | | | | | | | | |
| | | monomer | | | | | | | | | |
| | | MVOZ | | 25 | 25 | 25 | 25 | 25 | 25 | 25 | 25 |
| | Photo- | Acylphosphine | TPO-L | 8 | 10 | 11.5 | 10 | 7.5 | 7.5 | 8 | 9 |
| | polymerization | oxide compound | OmnTP | | | | | | | | |
| | initiator | | Omn819 | 4 | 2.5 | 1.5 | 5 | 3.5 | 3 | 2.5 | 1 |
| | | Thioxanthone | DETX | 3 | 2.5 | 2 | 3 | 0.5 | 1 | 5 | 8 |
| | | compound | OmnTX | | | | | | | | |
| | | Alkylaminoaceto- | Omn379 | | | | | | | | |
| | | phenone compound | | | | | | | | | |
| | | Benzoaminoate | ASA | | | | | | | | |
| | | compound | | | | | | | | | |

| | Polymerization | BHT | 0.1 | 0.1 | 0.1 | 0.1 | 0.1 | 0.1 | 0.1 | 0.1 |
|---|---|---|---|---|---|---|---|---|---|---|
| | inhibitor | | | | | | | | | |
| | Surface additive | UV3510 | 0.4 | 0.4 | 0.4 | 0.4 | 0.4 | 0.4 | 0.4 | 0.4 |
| Specifications | Specification of | DBP oil absorption amount (AC) | 43 | 43 | 43 | 43 | 43 | 43 | 43 | 43 |
| | carbon black | [mL/100 g] | | | | | | | | |
| | | Specific surface area (SC) | 62 | 62 | 62 | 62 | 62 | 62 | 62 | 62 |
| | | [m²/g] | | | | | | | | |
| | | AC × SC | 2666 | 2666 | 2666 | 2666 | 2666 | 2666 | 2666 | 2666 |
| | | pH | 3.5 | 3.5 | 3.5 | 3.5 | 3.5 | 3.5 | 3.5 | 3.5 |
| | | Primary particle size (nm) | 31 | 31 | 31 | 31 | 31 | 31 | 31 | 31 |
| | Specification of | Acid value [mgKOH/g] | 16 | 16 | 16 | 16 | 16 | 16 | 16 | 16 |
| | pigment dispersing | Amine value [mgKOH/g] | | | | | | | | |
| | resin | | 35 | 35 | 35 | 35 | 35 | 35 | 35 | 35 |
| | Content | Amount of carbon black | 2.7 | 2.7 | 2.7 | 2.7 | 2.7 | 2.7 | 2.7 | 2.7 |
| | in inkjet ink | Amount of polymerizable | 81.1 | 81.1 | 81.1 | 78.1 | 84.6 | 84.6 | 80.6 | 78.1 |
| | | compound | | | | | | | | |
| | | Amount of monofunctional | 0 | 0 | 0 | 0 | 0 | 0 | 0 | 0 |
| | | polymerizable compound | | | | | | | | |
| | | (excluding MVOZ) | | | | | | | | |
| | | Amount of bifunctional monomer | 39.6 | 39.6 | 39.6 | 39.6 | 39.6 | 39.6 | 39.6 | 39.6 |
| | | of general formula (A) | | | | | | | | |
| | | Amount of trifunctional monomer | 0 | 0 | 0 | 0 | 0 | 0 | 0 | 0 |
| | | of general formula (B) | | | | | | | | |
| | Ratio of content | Ratio of amount of bifunctional | (Not containing monomer of general formula (B)) | | | | | | | |
| | | monomer of general formula (A) | | | | | | | | |
| | | to amount of trifunctional | | | | | | | | |
| | | monomer of general formula (B) | | | | | | | | |
| | | Ratio of amount of other | 2.2 | 2.2 | 2.2 | 2.1 | 2.4 | 2.4 | 2.2 | 2.1 |
| | | polymerizable compound to | | | | | | | | |
| | | amount of MVOZ | | | | | | | | |
| | | Ratio of amount of | 0.48 | 0.48 | 0.48 | 0.60 | 0.44 | 0.42 | 0.42 | 0.40 |
| | | acylphosphine oxide compound | | | | | | | | |
| | | to amount of MVOZ | | | | | | | | |
| | | Ratio of (total) content of TPO-L | 53.3% | 66.7% | 76.7% | 55.6% | 65.2% | 65.2% | 51.6% | 50.0% |
| | | and/or TP to total amount of | | | | | | | | |
| | | photopolymerization initiator | | | | | | | | |
| | | Ratio of amount of | 4.0 | 4.0 | 4.0 | 5.0 | 22.0 | 10.5 | 2.1 | 1.3 |
| | | acylphosphine oxide compound | | | | | | | | |
| | | to amount of thioxanthone | | | | | | | | |
| | | compound | | | | | | | | |
| | | Ratio of amount of | 0.43 | 0.43 | 0.43 | 0.54 | 0.43 | 0.40 | 0.35 | 0.30 |
| | | acylphosphine oxide compound | | | | | | | | |
| | | to sum of amount of MVOZ and | | | | | | | | |
| | | amount of thioxanthone | | | | | | | | |
| | | compound | | | | | | | | |
| Evaluation | Evaluation 1 | Dispersion stability | 4 | 4 | 3 | 3 | 4 | 4 | 4 | 3 |
| results | Evaluation 2 | Discharge stability | 4 | 4 | 4 | 3 | 4 | 4 | 4 | 3 |
| | Evaluation 3 | Curability | 4 | 4 | 4 | 4 | 2 | 4 | 4 | 3 |
| | Evaluation 4 | Fineness of printed matter | 4 | 4 | 4 | 4 | 3 | 4 | 4 | 4 |
| | | (character visibility) | | | | | | | | |

| | | | Example / Comparative Example | | | | | | | | | |
|---|---|---|---|---|---|---|---|---|---|---|---|---|
| | | | Example 81 | Example 82 | Example 83 | Example 84 | Example 85 | | Example 86 | | Example 87 | |
| Inkjet ink No. | | | 90 | 91 | 92 | 93 | 94 | | 95 | | 96 | |
| Content | Carbon black | Carbon black dispersion No. used | 2 | 2 | 2 | 2 | 2 | 10 | 2 | 10 | 2 | 10 |
| | dispersion | Blending amount | 7 | 12 | 18 | 23 | 12 | 6 | 15 | 3 | 16.5 | 1.5 |

| Polymerizable | Radically | PDDA | | | | | | | |
|---|---|---|---|---|---|---|---|---|---|
| compound | polymerizable | BDDA | | | | | | | |
| | bifunctional | MPDDA | | | | | | | |
| | monomer | HDDA | 30 | 30 | 25 | 25 | 25 | 25 | 25 |
| | represented by | | | | | | | | |
| | general formula | | | | | | | | |
| | (A) | | | | | | | | |
| | Radically | GlyTA | | | | | 3 | 3 | 3 |
| | polymerizable | Gly(EO)3TA | | | | | | | |
| | trifunctional | Gly(EO)9TA | | | | | | | |
| | monomer | | | | | | | | |
| | represented by | | | | | | | | |
| | general formula | | | | | | | | |
| | (B) | | | | | | | | |
| | Other | CHA | | | | | | | |
| | monofunctional | IBXA | | | | | | | |
| | monomer | BzA | | | | | | | |
| | | VCL | | | | | | | |
| | Other | NDDA | | | | | | | |
| | bifunctional | DPGDA | 9 | 5 | 5 | 5 | 12 | 12 | 12 |
| | monomer | PEG400DA | 15 | 14 | 13 | 8 | 3 | 3 | 3 |
| | Other | TMP(EO)3TA | | | | | | | |
| | trifunctional | TMP(PO)2TA | | | | | | | |
| | monomer | | | | | | | | |
| | MVOZ | | 25 | 25 | 25 | 25 | 25 | 25 | 25 |
| Photo- | Acylphosphine | TPO-L | 7.5 | 7.5 | 7.5 | 7.5 | 7.5 | 7.5 | 7.5 |
| polymerization | oxide compound | OmnTP | | | | | | | |
| initiator | | Omn819 | 3 | 3 | 3 | 3 | 3 | 3 | 3 |
| | Thioxanthone | DETX | 3 | 3 | 3 | 3 | 3 | 3 | 3 |
| | compound | OmnTX | | | | | | | |
| | Alkylaminoaceto- | Omn379 | | | | | | | |
| | phenone compound | | | | | | | | |
| | Benzoaminoate | ASA | | | | | | | |
| | compound | | | | | | | | |

| | Polymerization | BHT | 0.1 | 0.1 | 0.1 | 0.1 | 0.1 | | 0.1 | | 0.1 | |
|---|---|---|---|---|---|---|---|---|---|---|---|---|
| | inhibitor | | | | | | | | | | | |
| | Surface additive | UV3510 | 0.4 | 0.4 | 0.4 | 0.4 | 0.4 | | 0.4 | | 0.4 | |
| Specifications | Specification of | DBP oil absorption amount (AC) | 43 | 43 | 43 | 43 | 43 | 120 | 43 | 120 | 43 | 120 |
| | carbon black | [mL/100 g] | | | | | | | | | | |
| | | Specific surface area (SC) | 62 | 62 | 62 | 62 | 62 | 175 | 62 | 175 | 62 | 175 |
| | | [m²/g] | | | | | | | | | | |
| | | AC × SC | 2666 | 2666 | 2666 | 2666 | 2666 | 21000 | 2666 | 21000 | 2666 | 21000 |
| | | ph | 3.5 | 3.5 | 3.5 | 3.5 | 3.5 | 4 | 3.5 | 4 | 3.5 | 4 |
| | | Primary particle size (nm) | 31 | 31 | 31 | 31 | 31 | 25 | 31 | 25 | 31 | 25 |
| | Specification of | Acid value [mgKOH/g] | 16 | 16 | 16 | 16 | 16 | 16 | 16 | 16 | 16 | 16 |
| | pigment dispersing | Amine value [mgKOH/g] | | | | | | | | | | |
| | resin | | 35 | 35 | 35 | 35 | 35 | 35 | 35 | 35 | 35 | 35 |

| | Content | Amount of carbon black | 1.05 | 1.8 | 2.7 | 3.45 | 2.7 | 2.7 | 2.7 |
|---|---|---|---|---|---|---|---|---|---|
| | in inkjet ink | Amount of polymerizable | 84.7 | 83.7 | 82.6 | 81.7 | 82.6 | 82.6 | 82.6 |
| | | compound | | | | | | | |
| | | Amount of monofunctional | 0 | 0 | 0 | 0 | 0 | 0 | 0 |
| | | polymerizable compound | | | | | | | |
| | | (excluding MVOZ) | | | | | | | |
| | | Amount of bifunctional monomer | 35.7 | 39.7 | 39.6 | 43.7 | 39.6 | 39.6 | 39.6 |
| | | of general formula (A) | | | | | | | |
| | | Amount of trifunctional monomer | 0 | 0 | 0 | 0 | 3 | 3 | 3 |
| | | of general formula (B) | | | | | | | |
| | Ratio of content | Ratio of amount of bifunctional | (Not containing monomer of general formula (B)) | | | | 13.2 | 13.2 | 13.2 |
| | | monomer of general formula (A) | | | | | | | |
| | | to amount of trifunctional | | | | | | | |
| | | monomer of general formula (B) | | | | | | | |
| | | Ratio of amount of other | 2.4 | 2.3 | 2.3 | 2.3 | 2.3 | 2.3 | 2.3 |
| | | polymerizable compound to | | | | | | | |
| | | amount of MVOZ | | | | | | | |
| | | Ratio of amount of | 0.42 | 0.42 | 0.42 | 0.42 | 0.42 | 0.42 | 0.42 |
| | | acylphosphine oxide compound | | | | | | | |
| | | to amount of MVOZ | | | | | | | |
| | | Ratio of (total) content of TPO-L | 55.6% | 55.6% | 55.6% | 55.6% | 55.6% | 55.6% | 55.6% |
| | | and/or TP to total amount of | | | | | | | |
| | | photopolymerization initiator | | | | | | | |
| | | Ratio of amount of | 3.5 | 3.5 | 3.5 | 3.5 | 3.5 | 3.5 | 3.5 |
| | | acylphosphine oxide compound | | | | | | | |
| | | to amount of thioxanthone | | | | | | | |
| | | compound | | | | | | | |
| | | Ratio of amount of | 0.38 | 0.38 | 0.38 | 0.38 | 0.38 | 0.38 | 0.38 |
| | | acylphosphine oxide compound | | | | | | | |
| | | to sum of amount of MVOZ and | | | | | | | |
| | | amount of thioxanthone | | | | | | | |
| | | compound | | | | | | | |
| Evaluation | Evaluation 1 | Dispersion stability | 4 | 4 | 4 | 4 | 3 | 3 | 4 |
| results | Evaluation 2 | Discharge stability | 4 | 4 | 4 | 3 | 2 | 3 | 4 |
| | Evaluation 3 | Curability | 4 | 4 | 4 | 3 | 3 | 4 | 4 |
| | Evaluation 4 | Fineness of printed matter | 4 | 4 | 4 | 4 | 4 | 4 | 4 |
| | | (character visibility) | | | | | | | |

Note that details of the abbreviations used in Table 4 are as follows. Abbreviations not described below are as described above in Tables 1 to 3.
PDDA: 1,3-propanediol diacrylate
BDDA: 1,4-butanediol diacrylate
MPDDA: 3-methyl-1,5-pentanediol diacrylate
GlyTA: glycerin triacrylate
Gly(EO)3TA: ethylene oxide-modified glycerin triacrylate (the number of ethylene oxide groups: 3)
Gly(EO)9TA: ethylene oxide-modified glycerin triacrylate (the number of ethylene oxide groups: 9)
CHA: cyclohexyl acrylate
IBXA: isobornyl acrylate
BzA: benzyl acrylate
VCL: N-vinylcaprolactam
PEG400DA: polyethylene glycol 400 diacrylate
TMP(EO)3TA: ethylene oxide-modified trimethylolpropane triacrylate (the number of ethylene oxide groups: 3)
TMP(PO)2TA: propylene oxide-modified trimethylolpropane tri(meth)acrylate (the number of propylene oxide groups: 2)
MVOZ: 5-methyl-3-vinyloxazolidin-2-one
TPO-L: ethoxyphenyl (2,4,6-trimethylbenzoyl) phosphine oxide (“Omnirad TPO-L” manufactured by IGM RESINS B.V.)
OmnTP: multimer of ethoxyphenyl (2,4,6-trimethylbenzoyl) phosphine oxide (“OMNIPOL TP” manufactured by IGM RESINS B.V.)
Omn819: phenylbis(2,4,6-trimethylbenzoyl) phosphine oxide (“Omnirad 819” manufactured by IGM RESINS B.V.)
DETX: 2,4-diethylthioxanthone (“Omnirad DETX” manufactured by IGM RESINS B.V.)
OmnTX: multimer of 3-ethoxycarbonylmethoxythioxanthone (“OMNIPOL TX” manufactured by IGM RESINS B.V.)
Omn379:2-(dimethylamino)-2-(4-methylbenzyl)-1-(4-morpholinophenyl) butan-1-one (“Omnirad 379” manufactured by IGM RESINS B.V.)
ASA: polyethylene glycol-bis(p-dimethylaminobenzoate) (“Omnipol ASA” manufactured by IGM RESINS B.V.)
BHT: 2,6-di-tert-butyl-4-methylphenol
UV3510: polyether-modified siloxane-based surface additive (“BYK-UV3510” manufactured by BYK Japan KK)

### <Manufacture of Printed Matter>

Using each of the inkjet inks prepared above, a printed matter was manufactured by the following method.

One temperature-adjustable inkjet head (KJ4A, design resolution: 600 dpi) manufactured using KYOCERA Corporation was mounted above a conveyor capable of conveying a printing substrate. In addition, an LED lamp for full curing (FirePower FP300 manufactured by Phoseon Technology (maximum emission wavelength: 395 nm, maximum intensity: 16,000 mW/cm²)) was equipped on a downstream side of the printing substrate in a conveyance direction.

The inkjet ink previously manufactured was filled into the inkjet head. Next, the temperature of the inkjet head was adjusted such that the viscosity of the inkjet ink at the time of discharge was 6 to 7 mPa·s. Thereafter, a PET substrate “K2411” manufactured by Lintec Corporation was fixed onto the conveyor, and then the conveyor was operated at a speed of 50 m/min. When the PET substrate passed through a portion where the inkjet head was mounted, droplets of the inkjet ink were discharged from the inkjet head, and printing was performed. Specifically, a solid image with a coverage rate of 100% and a character image were printed under printing conditions of a discharge droplet amount of 11 μL and a printing resolution of 600 dpi×600 dpi. The character image is where 20 random hiragana characters were printed in each of sizes of 4 points, 6 points, and 8 points using MS Mincho style. Next, after the inkjet ink was printed, the conveyor was driven at the same speed as it was, and when the PET substrate passed through the portion where the LED lamp for full curing was equipped, irradiation with an ultraviolet ray was performed to manufacture a printed matter. Note that an output of the LED lamp was adjusted in advance such that an intensity of the ultraviolet ray with which the inkjet ink after printing was irradiated was 6,000 mW/cm² and an integrated light intensity was 150 mJ/cm², and then the printing described above was performed.

### Examples 1 to 87 and Comparative Examples 1 to 9

Various evaluations were performed according to the following method using the inkjet inks and the printed matters manufactured using the above-described method. Evaluation results are as shown in Table 4.

### <Evaluation 1: Evaluation of Dispersion Stability>

The secondary particle size of each of the inkjet inks was measured immediately after the manufacture using the measuring apparatus and method described above. Next, each of the inkjet inks was filled into a glass container having a volume of 20 mL so as to have a filling ratio of 80% of the container volume. Thereafter, the glass container into which the inkjet ink had been filled was allowed to stand in an environment at 60° C. for two weeks in a state of being sealed and light-shielded, and then the secondary particle size of the inkjet ink after being allowed to stand was measured again. By calculating the increase ratio between the secondary particle size before standing and the secondary particle size after standing, dispersion stability was evaluated. Evaluation criteria of the dispersion stability were as follows, and a sample evaluated as “2” or higher was regarded as a practical, and a sample evaluated as “3” or higher was regarded as suitable for practical use.

### (Evaluation Criteria for Dispersion Stability)

4: The increase ratio of the secondary particle size was less than 10%
3: The increase ratio of the secondary particle size was 10% or more and less than 20%
2: The increase ratio of the secondary particle size was 20% or more and less than 30%
1: The increase ratio of the secondary particle size was 30% or more

### <Evaluation 2: Evaluation of Discharge Stability>

Each inkjet ink was filled into a jig equipped with a temperature-adjustable inkjet head (KJ4A, design resolution: 600 dpi) manufactured by KYOCERA Corporation. Next, the temperature of the inkjet head was adjusted such that the viscosity of the inkjet ink at the time of discharge was 6 to 7 mPa·s. Thereafter, it was confirmed that there was no nozzle from which the inkjet ink was not discharged, and then the inkjet ink was continuously discharged from all the nozzles at a drive frequency of 20 kHz. Then, continuous discharge was performed for five minutes, and then the number of nozzles (the number of nozzle losses) from which the inkjet ink was not discharged was counted, whereby discharge stability was evaluated. Evaluation criteria of the discharge stability were as follows, and a sample evaluated as “2” or higher was regarded as practical.

Note that, in the evaluation of dispersion stability described above, as for an inkjet ink evaluated as “1”, the inkjet head was highly likely to be damaged, and thus discharge stability was not evaluated.

### (Evaluation Criteria for Discharge Stability)

4: The number of nozzle losses was 0 to 2.
3: The number of nozzle losses was 3 to 5.
2: The number of nozzle losses was 6 to 9.
1: The number of nozzle losses was 10 or more.

### <Evaluation 3: Evaluation of Curability>

A surface of the solid image printed matter having a coverage rate of 100%, prepared using the above method was rubbed with a cotton swab, and was confirmed whether or not the ink in an uncured state adhered to the cotton swab. When the inkjet ink adhered to the cotton swab, the printed matter was fixed to the conveyor of the inkjet printing apparatus, and only irradiation with the LED lamp for full curing was performed without performing inkjet ink printing, and was confirmed whether or not adhesion of the inkjet ink adhered again when the surface of the printed matter was rubbed with a cotton swab. This action was repeated, and the number of times of passage required until the inkjet ink in an uncured state no longer adhered to a cotton swab was examined, whereby curability was evaluated. Evaluation criteria of the curability were as follows, and a sample evaluated as “2” or higher was regarded as a practical one, and a sample evaluated as “3” or higher was regarded as practical.

### (Evaluation Criteria for Curability)

4: An ink in an uncured state no longer adhered to a cotton swab after a total of one passage (no need of additional ultraviolet irradiation).
3: An ink in an uncured state no longer adhered to a cotton swab after a total of two passages (when additional ultraviolet irradiation was performed once).
2: An ink in an uncured state no longer adhered to a cotton swab after a total of three passages (when additional ultraviolet irradiation was performed twice).
1: It was necessary to perform irradiation with the LED lamp four or more times in total until an inkjet ink in an uncured state no longer adhered to a cotton swab.

### <Evaluation 4: Evaluation of Fineness (Character Visibility) of Printed Matter>

Whether hiragana characters in a character image prepared by the above method could be read was visually confirmed, whereby fineness (character visibility) of a printed matter was evaluated. Evaluation criteria of the fineness were as follows, and a sample evaluated as “2” or higher was regarded as a practical one, and a sample evaluated as “3” or higher was regarded as a practically preferable one.

### (Evaluation Criteria of Fineness (Character Visibility) of Printed Matter)

4: All 20 hiragana characters were distinguishable in all of 4 points, 6 points, and 8 points.
3: All 20 hiragana characters were distinguishable in all of 6 points and 8 points, but some of hiragana characters printed in 4 points were indistinguishable.
2: All 20 hiragana characters were distinguishable in all 8 points, but some of hiragana characters printed in 6 points were indistinguishable.
1: Some of hiragana characters printed in 8 points were indistinguishable.

As presented in Table 4, the inkjet inks of Examples 1 to 87 having the above-described compositions were excellent in all of dispersion stability of carbon black, discharge stability, curability, and fineness of a printed matter.

Meanwhile, in the inkjet inks of Comparative Examples 1 to 4 using each carbon black in which a value of a product (AC×SC) of a DBP oil absorption amount (AC) and a specific surface area (SC) was larger than 12,000, dispersion stability and discharge stability did not reach practical levels. In addition, in the inkjet inks of Comparative Examples 3 and 4 in which a value of the above product was particularly large, curability and fineness of a printed matter were at practical levels, but did not reach practically preferable levels. Meanwhile, in the inkjet inks of Examples 1 to 7 using carbon black in which a value of the above product was 2,000 to 12,000, dispersion stability and discharge stability were at practicable levels, and curability and fineness of a printed matter were at practically preferable levels. From the above results, it was confirmed that control of a value of the above product is important for exhibiting the above-described effect.

In addition, in Comparative Example 5 using Solsperse41000 which is an acidic pigment dispersing resin and Comparative Example 6 using a basic pigment dispersing resin having an acid value of more than 30 mgKOH/g (DISPERBYK-180), dispersion stability and discharge stability did not reach practical levels. In these examples, it is considered that since the acid value of the pigment dispersing resin used was too large, an acid group in the pigment dispersing resin reacted with a vinyl group in 5-methyl-3-vinyloxazolidin-2-one, and dispersion stability of each carbon black and discharge stability were deteriorated.

In the inkjet ink of Comparative Example 7, the content of a monofunctional polymerizable compound excluding 5-methyl-3-vinyloxazolidin-2-one was more than 15% by mass, and as a result of evaluation, it was confirmed that curability did not reach a practical level. In addition, fineness of a printed matter was at a practical level, but did not reach a practically preferable level.

In the inkjet ink of Comparative Example 8 in which N-vinylcaprolactam, which is a representative example of an N-vinyl compound, was used instead of 5-methyl-3-vinyloxazolidin-2-one, dispersion stability did not reach a practicable level, and curability and fineness of a printed matter were at practicable levels, but did not reach practically preferable levels. The inkjet ink of Comparative Example 8 was significantly inferior in quality to the inkjet ink of Example 2 using 5-methyl-3-vinyloxazolidin-2-one instead of N-vinylcaprolactam. From this, it was confirmed that 5-methyl-3-vinyloxazolidin-2-one was an essential material in the inkjet ink of the present embodiment.

Furthermore, importance of 5-methyl-3-vinyloxazolidin-2-one in the inkjet ink of the present embodiment was also confirmed from the fact that in the inkjet ink of Comparative Example 9 not containing the 5-methyl-3-vinyloxazolidin-2-one, curability and fineness of a printed matter did not reach practicable levels.

1. An active energy ray-curable inkjet black ink comprising: carbon black; a basic pigment dispersing resin; and a polymerizable compound, wherein
when a DBP oil absorption amount of the carbon black is represented by AC (mL/100 g) and a specific surface area of the carbon black is represented by SC (m²/g), a value represented by AC×SC is 2,000 to 12,000,
the basic pigment dispersing resin has an acid value of 30 mgKOH/g or less,
the polymerizable compound contains 5-methyl-3-vinyloxazolidin-2-one, and
a content of a monofunctional polymerizable compound (excluding the 5-methyl-3-vinyloxazolidin-2-one) is 15% by mass or less with respect to a total mass of the active energy ray-curable inkjet black ink.

2. The active energy ray-curable inkjet black ink according to claim 1, wherein
the polymerizable compound contains a radically polymerizable bifunctional monomer represented by general formula (A) below, and
a content of the radically polymerizable bifunctional monomer represented by the general formula (A) is within a range from 15% to 55% by mass with respect to a total mass of the active energy ray-curable inkjet black ink. 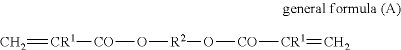
where R¹ represents a hydrogen atom or a methyl group, and R² represents an alkylene group having 3 to 6 carbon atoms and optionally having a branched structure.

3. The active energy ray-curable inkjet black ink according to claim 1, wherein
the polymerizable compound contains a radically polymerizable trifunctional monomer represented by general formula (B) below, and
a content of the radically polymerizable trifunctional monomer represented by the general formula (B) is within a range from 2% to 15% by mass with respect to a total mass of the active energy ray-curable inkjet black ink. 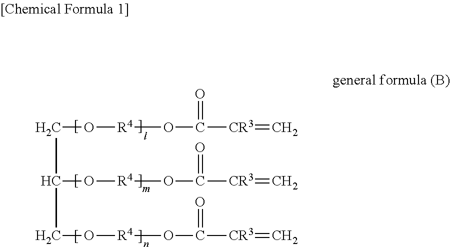
where R³ represents a hydrogen atom or a methyl group, and R⁴ represents an ethylene group or a propylene group, 1, m and n each represent an integer of 0 to 9, and 1+m+n is an integer of 0 to 9.

4. The active energy ray-curable inkjet black ink according to claim 1, further comprising a photopolymerization initiator, wherein
the photopolymerization initiator contains an acylphosphine oxide-based compound.

5. The active energy ray-curable inkjet black ink according to claim 4, wherein the photopolymerization initiator further contains a thioxanthone-based compound.

6. The active energy ray-curable inkjet black ink according to claim 4 or 5, wherein
the acylphosphine oxide-based compound contains at least one selected from the group consisting of ethoxyphenyl (2,4,6-trimethylbenzoyl) phosphine oxide and a multimer of ethoxyphenyl (2,4,6-trimethylbenzoyl) phosphine oxide, and
a total of a content of the ethoxyphenyl (2,4,6-trimethylbenzoyl) phosphine oxide and a content of the multimer of the ethoxyphenyl (2,4,6-trimethylbenzoyl) phosphine oxide is within a range from 45% to 80% by mass with respect to a total mass of the photopolymerization initiator.

7. The active energy ray-curable inkjet black ink according to claim 1, wherein the carbon black has a pH of 2 to 5.

8. A printed matter obtained by printing the active energy ray-curable inkjet black ink according to claim 1 on a printing substrate.
